(19) United States
(12) Patent Application Publication
(10) Pub. No.: US 2016/0042315 A1
(43) Pub. Date: Feb. 11, 2016

(54) SYSTEM AND METHODS FOR ORDER FULFILLMENT, INVENTORY MANAGEMENT, AND PROVIDING PERSONALIZED SERVICES TO CUSTOMERS

(71) Applicant: Nordstrom, Inc., Seattle, WA (US)

(72) Inventors: Kelli Dawn Field-Darragh, Snoqualmie, WA (US); Eric Jon Olson, Seattle, WA (US); Benjamin Michael Shiner, Edmonds, WA (US)

(21) Appl. No.: 14/887,256

(22) Filed: Oct. 19, 2015

Related U.S. Application Data
(63) Continuation of application No. 13/827,724, filed on Mar. 14, 2013, now abandoned.

(51) Int. Cl. G06Q 10/08; H04B 5/00

(52) U.S. Cl. CPC G06Q 10/087; H04B 5/0062

(57) ABSTRACT

A system and methods for use in order intake, order fulfillment, inventory management, and the development of personalization services for customers, including a system and data processing elements for generating, acquiring and processing data related to the location and movement of merchandise within a store or other location. By processing such data the inventive system can assist customers or store employees to locate an item for purposes of fulfilling an order, determine if an item should be removed from inventory, generate recommendations to a customer regarding items that might be of interest, provide inputs to sales and marketing functions about what products are examined by customers and converted into sales, and provide other value-added services. As a result, embodiments of the invention can provide store operators, store employees, and customers with improved services and more efficient operations.

### PRIORITY CLAIM

This application is a continuation of U.S. patent application Ser. No. 13/827,724 filed on Mar. 14, 2013. The foregoing application is incorporated herein by reference in its entirety.

### TECHNICAL FIELD

Embodiments of the invention relate to improvements to commerce services provided to customers and to the operations of vendors that provide those services. Specifically, embodiments of the invention relate to a system and computer automated methods for improving order fulfillment and inventory management functions, and to providing a set of value-added services for customers. The inventive system and methods are responsible for generating, acquiring and processing data related to the location and movement of merchandise within a store or other location, and as a result are able to provide store operators, store employees, and customers with improved services and more efficient operations.

### BACKGROUND

Whether an entity is operating a physical storefront, a warehouse, a virtual storefront accessible over the Internet (such as might be part of an eCommerce web-site) or a combination of these “facilities”, there are certain business functions that are typically required to efficiently provide products or services to customers. These functions include order intake (which may involve providing a catalog of available products and services or other data to prospective customers and enabling them to place an order), order processing, order fulfillment (which may include determining how to fulfill the order from one or more possible sources of the product or service, and then providing the ordered merchandise or service to the customer), inventory management (which may include updating available stocks of merchandise efficiently in response to sales of items through multiple distribution channels to provide a more accurate accounting of available merchandise that may be used to fulfill orders), and customer support services to assist employees in providing services to customers.

As customers have become accustomed to multiple ways of interacting with a business and placing orders, they have also become more interested in having additional ways of having those orders fulfilled. For example, customers may wish to have several different ways of viewing the merchandise and services available from a business, such as a physical catalog, on-line catalog, searchable listing, etc. In this sense they wish to have a large amount of information available to them to assist in identifying the specific item or service they wish to purchase. They also wish to have this information structured and reviewable in an efficient way so that they can get the most value from it. Further, customers may desire to have several different ways of placing an order, depending on their location or situation at the time (e.g., an application on their mobile device, a web-site accessible over the Internet by a desktop or laptop computer, a telephone order service, an email order service, an in-store kiosk, etc.). In addition, customers may desire to be provided with options for how an order will be fulfilled; these options may depend on the immediacy of their need for the item or service, the pricing options available (which may depend on delivery time or condition of the item), the manner in which the item or service will be transferred to the customer (e.g., in person, via mail, via package delivery, via courier). In general, as customers are provided with more options they seek to have greater flexibility in their use of those options. Businesses that can satisfy this desire for greater flexibility by providing the appropriate customer oriented support services will enhance their reputations and the satisfaction of their customers.

In addition to the services and benefits desired by customers, retailers may also desire to be able to leverage their in-store inventory to fulfill items requested by a consumer from one of several different purchasing channels. This may enable a retailer to better control inventory levels, rotation of merchandise, profit margins, and other features of their business by viewing their entire enterprise as one source of product with multiple ordering and delivery channels, instead of as multiple sources each with a separate ordering and delivery channel.

One of the challenges facing businesses that seek to provide a variety of ways for customers to review merchandise and place orders, and then to receive the merchandise or services they requested in an efficient manner is that of successfully integrating the variety of ordering and distribution channels with their other operations and functions. This is because it is difficult to maintain accurate and relatively up to date information about the availability of specific merchandise when an organization may be taking orders for and distributing merchandise through a variety of channels. Further, a lack of current information may cause an organization's employees to be unable to efficiently respond to a customer's request for merchandise or to provide assistance in selecting merchandise. Over time, these and similar problems may contribute to a reduction in consumer confidence or satisfaction with a particular store or organization, and hence in the reputation and brand value of the organization.

For example, Internet based online stores and eCommerce web-sites have increasingly become used by customers and prospective customers to identify and/or purchase goods and services. In addition, customers and prospective customers have demonstrated an interest in being able to use a variety of devices for reviewing inventory, placing orders, and receiving notifications regarding delivery of those orders. Still further, customers and prospective customers have indicated a desire that vendors utilize a variety of distribution channels to fulfill their orders, where such channels may include postal mail delivery, package delivery services, in-store pickup, courier delivery, etc. The result is that customers seek to have a greater variety of ways in which to access inventory, place orders, and receive the merchandise or services they have purchased. This may include both online and retail storefronts, multiple types of communication networks and user devices, and multiple ways in which they may receive what they ordered (such as in person in a physical store, or via mail, package delivery, etc.).

While creating new opportunities to provide a high level of service to customers, these developments have also created new challenges for vendors and their employees who interface with customers. Many of these challenges arise from the need to maintain a high degree of customer satisfaction regarding the availability, quality, and delivery of merchandise while managing complex logistical problems involving order fulfillment and inventory management. As recognized by the inventors, solutions to these challenges will enable more efficient operation of businesses while increasing customer satisfaction, and in some instances may lead to the development of new customer oriented services that can increase a customer's satisfaction with a business.

As one example, customers have indicated a desire to be able to review inventories and place orders on-line when ordering from a traditional physical storefront business (commonly referred to as a “brick and mortar” business). To meet this demand, it is now common for many operators of a store or stores to provide a branded website that includes an on-line store that enables a consumer to purchase many of the same goods or services that are available in an operator's physical retail store. However, as will be described, this benefit to customers presents a possible problem with regards to fulfilling an order placed using one of several methods that is to be delivered via a distribution channel preferred by a customer. Further, it may create additional concerns regarding the management of inventory that is located in multiple stores and/or warehouse facilities and the expectations for the availability or delivery of an item that may be communicated to a customer.

Internet only retailers (i.e., those having no brick and mortar storefront) typically employ one or more centralized warehouse-based fulfillment centers for receiving, processing, and shipping orders that are initiated using their online store. Likewise, traditional brick and mortar retailers often use one or more centralized warehouse-based fulfillment centers for receiving, processing, and shipping orders that are made using their online store. But, unlike Internet only retailers, traditional retailers typically also have a significant amount of inventory that is physically located in both their retail stores and their centralized warehouses (which may house inventory used to fulfill online orders and that used to display and sell in physical stores). This provides another option for fulfilling an order, as the stores and warehouses may contain similar styled merchandise, but of different condition, sizes, or colors. Further, this additional option may be preferred by a customer due to a need to try on the item, compare it to another item in the store, obtain it quickly, or have the item shipped to a location they plan to be in at a later time.

As noted, orders for goods purchased from a traditional retailers' online store are typically fulfilled with inventory from a centralized warehouse-based fulfillment center, and not from inventory located in a retail store. Similarly, an order placed in a retail store is typically fulfilled with inventory located on-site in the store, in a nearby store, or from a warehouse associated with the store or stores. If the centralized warehouse was out of stock of a particular item ordered by a customer through the online store, the order would not be fulfilled at that time, even if it was available in a retail store. This potentially represents a “missed opportunity” to fulfill the order and generate further goodwill towards the retailer on the part of the customer. It also may represent a missed opportunity to recommend other items to the customer that would be complementary to the item they ordered, especially if those items are more likely to be purchased when viewed as part of a collective whole with the ordered item. A variation on this scenario is where a customer visits a physical store but cannot find what they want or cannot find an item in the condition they want. If fulfillment is limited to that store and perhaps one or two nearby stores, then the customer may leave dissatisfied, and an opportunity to enhance the reputation of the store's customer service may be lost.

This suggests that it would be desirable to be able to offer a customer a greater number of options with regards to available inventory from which to select an item, as well as with regards to how a selected item will be delivered or otherwise provided to them. For example, a customer may desire to be able to (1) have an ordered fulfilled at a local physical storefront when they place an order on-line (where the item is presently located at a different store, warehouse, or another location), (2) view and select an item located in a physical store as part of the inventory available for purchase through an on-line transaction for pick up at that store, or (3) view and select an item located in a physical store as part of the inventory available for purchase through an on-line transaction for delivery by another means (such as mail, package delivery, etc.).

Note that an in-store pickup option may be desirable to a customer regardless of the availability of the item through the standard fulfillment channels for on-line orders (e.g., mail, package delivery, etc.), as it may enable the customer to try the item in-store and/or be offered other items to consider purchasing at that time. This may reduce returns and the associated processing overhead, increase the purchase of complementary items, and provide store personnel with another opportunity to interact with the customer. The end result may be reduced costs, increased sales, and greater customer satisfaction. Similarly, it would be desirable to offer a customer the option of having an in-store order or request fulfilled through a centralized warehouse or a distant store (this may be preferable if the condition of the item in-store is not as desired or if the customer desires that the item be delivered to a specified address). In addition, by making the in-store inventory available to a customer as a source of items to purchase, the customer may be provided with additional options, a greater variety of possible items, additional promotional offers, etc. that enable a sales opportunity in a situation in which it would not otherwise occur. This benefits customers and retailers by making a larger inventory available for purchase, and possibly also increasing the items or types of items that a customer becomes aware of.

However, effectively fulfilling an on-line order for an item located in a store or warehouse can be problematic for several reasons. Merchandise may be moved around various locations within a store or warehouse, it may be of uncertain quality due to its presence in a customer facing location, it may no longer be physically located at a particular store due to theft or other removal reason, or it may have been moved to a different store or warehouse. Further, an item for which an order is placed on-line may be desired to be purchased by an in-store customer or be in their physical possession, or the item may have experienced an event within its lifecycle that reduced its desirability for use in fulfillment (e.g., the item was previously purchased and returned). These situations create a problem in terms of locating an item that is suitable for fulfilling an order, enabling the customer or a store employee to find the item if it is located within a physical store, and maintaining a relatively current knowledge of the inventory available for fulfillment in response to incoming on-line or in-store orders.

What is desired are a system and methods for enabling efficient fulfillment of an order placed by a customer either on-line or in-store, where the item may be located in one of one or more physical stores or warehouses. Embodiments of the invention are directed toward solving these and other problems individually and collectively.

### SUMMARY

Embodiments of the invention are directed to systems and methods for use in order intake, order fulfillment, inventory management, and the development of personalization services for customers. In some embodiments, the invention is directed to a system and data processing elements for generating, acquiring and processing data related to the location, movement, and lifecycle events of an item of merchandise within a store or other location. By processing such data the inventive system can assist customers or store employees to locate an item for purposes of fulfilling an order, determine if an item should be removed from inventory, generate recommendations to a customer regarding items that might be of interest, provide inputs to sales and marketing functions about what products are examined by customers and converted into sales, and provide other value-added services. As a result, embodiments of the invention can provide store operators, store employees, and customers with improved services and more efficient operations.

In some embodiments, the inventive system and methods include elements that enable a determination of the location of a specific item within a physical space (such as a store). The location may be determined relative to another item or structure whose location is known, thereby providing a reference location. An item's location may be used to generate data used to guide a customer or store employee to the item for purposes of purchase or order fulfillment. In some embodiments, the inventive system and methods may determine the location of a specific item or group of items over a certain time period. This “movement profile” may then be used to assist in determining the most appropriate fulfillment process for an item desired by a customer, the likelihood of purchase of an item after it is selected for consideration by a potential buyer, the identification of potentially undesirable items or highly desirable items, the optimal placement of an item or items within the physical space, as well as other value-added services for both customers and store employees.

In some embodiments, the number of times an item is detected to have been moved into or out of a certain region of a store or warehouse (alone or in combination with certain item lifecycle events) may be used to infer the condition or desirability of the item, either individually or as part of a group of items. Such information may assist in making decisions regarding the placement or rotation of merchandise, the effectiveness of marketing or promotional efforts, or suggest possible recommendations that may be made to customers.

In some embodiments, the inventive system and methods may include a passive or active “tag” or identifier that is associated with each item located within a physical space. Examples of a suitable tag include a radio frequency identification (RFID) tag or one that exchanges data by use of a near field communications (NFC) mechanism, Such a tag may be incorporated into the item (such as being sewn into a seam of a shirt or placed inside the sole of a shoe) or otherwise connected to the item. The tag may actively transmit an identification code or string associated with the tag. Similarly, the tag may transmit information about the item, such as its SKU or inventory number. The tag may respond to a scanning signal and in response transfer the information to a scanner or data collection point. The tag may also provide or be induced to provide the information to another tag located on an item or structure, from which the information is communicated to a data collection point. Scanners or another form of detector may be placed, deployed, arranged, or otherwise used in a plurality of locations within a store or warehouse, and used to determine the location and movement of an item or group of items. Data processing elements may then use the location, item lifecycle event history, and movement data for an item or multiple items as inputs to an order processing/fulfillment process that determines how to provide a customer or store employee with the item in a desired manner (e.g., fastest, at lowest total cost, in the best condition, with the least amount of customer effort, etc.). Furthermore, as recognized by the inventors, the location, item lifecycle event history, and/or movement data for an item or multiple items may be used to improve inventory management processes and to provide additional value-added services to customers.

In one embodiment, the invention is directed to a system for fulfilling a request for an item, where the system includes:
a first data transfer element associated with the item and configured to transfer identifying data for the first data transfer element to a receiver;
a second data transfer element associated with a structure or fixture on which the item is placed, or with a region of a store or warehouse in which the item is located, and configured to transfer identifying data for the second data transfer element to the receiver;
a communications network coupled to the receiver and configured to transfer the identifying data for the first data transfer element and the identifying data for the second data transfer element; and
a data processor coupled to the communications network and including a processing element programmed with a set of instructions, the processing element configured by the set of instructions to perform the steps of
   using the identifying data for the first data transfer element to access data identifying the item and using the identifying data for the second data transfer element to access data identifying the structure or fixture, or the region of the store or warehouse;
   determining a location of the item based on the accessed data;
   determining a fulfillment confidence score for the item, wherein, the fulfillment confidence score is based at least in part on data representing one or more locations within the store or warehouse at which the item has previously been located; and
   determining, based on the fulfillment confidence score, if the item is suitable for use in following the request.

In another embodiment, the invention is directed to a method of fulfilling a request for an item, where the method includes:
acquiring data corresponding to a plurality of locations of the item within a store or warehouse over a predetermined period of time;
processing the acquired data to generate a fulfillment confidence score for the item;
determining, based on the fulfillment confidence score, if the item is suitable for use in fulfilling the request; and
using the item to fulfill the request if the fulfillment confidence score is suitable.

### BRIEF DESCRIPTION OF THE DRAWINGS

Non-limiting and non-exhaustive embodiments of the invention are described with reference to the following drawings. In the drawings, like reference numerals refer to like parts throughout the various figures, unless otherwise specified, wherein:

FIG. 1 is a block diagram illustrating a system of elements that may be used in whole or in part in implementing an embodiment of the invention;

FIG. 2 is a functional block diagram illustrating elements of a network device or server that may be used in whole or in part in implementing an embodiment of the invention;

FIG. 3 is a functional block diagram illustrating elements of a client device that may be used in whole or in part in implementing an embodiment of the invention;

FIG. 4 is a diagram illustrating certain elements of an environment (in this case, a retail store) and of the inventive system that may be used in whole or in part in implementing an embodiment of the invention;

FIGS. 5, 6, and 7 are illustrations of exemplary screen displays that may be displayed on a hand held device, kiosk, point of sale terminal, computer display screen or any other suitable device for the purpose of assisting a store or warehouse employee to “pick” a set of items for one or more customers, and that may be used in whole or in part in implementing an embodiment of the invention;

FIG. 8 is a flow chart or flow diagram illustrating an example process 800 for providing inventory services that may be used as part of a fulfillment process in accordance with an embodiment of the invention;

FIG. 9 is a flow chart or flow diagram illustrating an example process 900 for managing the availability of items in a retail store inventory that may be used as part of a fulfillment process in accordance with an embodiment of the invention;

FIG. 10 is a flow chart or flow diagram illustrating an example process 1000 for using fulfillment confidence score(s) and that may be used as part of a fulfillment process in accordance with an embodiment of the invention;

FIG. 11 is a flow chart or flow diagram illustrating an example process 1100 for managing location and/or lifecycle event data in a retail store inventory and that may be used as part of a fulfillment process in accordance with an embodiment of the invention;

FIG. 12 is a flow chart or flow diagram illustrating an example process 1200 for a fulfillment process using item tag data that may be used in accordance with an embodiment of the invention; and

FIG. 13 is a diagram illustrating an example item “lifecycle” and events in that lifecycle as they relate to a fulfillment confidence score, in accordance with an embodiment of the invention.

### DETAILED DESCRIPTION

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied in whole or in part as a system, as one or more methods, or as one or more devices. Embodiments of the invention may take the form of an entirely hardware implemented embodiment, an entirely software implemented embodiment or an embodiment combining software and hardware aspects. For example, in some embodiments, one or more of the operations, functions, processes, or methods described herein may be implemented by a suitable processing element (such as a processor, microprocessor, CPU, controller, etc.) that is programmed with a set of executable instructions (e.g., software instructions), where the instructions may be stored in a suitable data storage element. The following detailed description is, therefore, not to be taken in a limiting sense.

The subject matter of embodiments of the invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

### EXEMPLARY TERMINOLOGY AND DESCRIPTIONS

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The term “order,” as used herein, is used to describe a transaction made by a consumer/customer. An order may be initiated by a customer or employee, and may be initiated by use of an on-line store, an in-store kiosk, a point of sale terminal, a web-site accessed using a suitable computing device, an application installed on a mobile device, or by any other suitable method or device. Orders may include multiple order items. In at least one of the exemplary embodiments, orders may be implemented using well-known data structures that include consumer information, such as (but not limited to or requiring), name, telephone number, shipping address, billing/payment information, or the like. Orders also include sufficient information to identify the good and services the consumer has purchased (or intends to purchase).

The term “order item,” as used herein, is used to describe a portion of an order. Generally, an individual order may include multiple items or services, such as a shirt and a tie. Each good or service that comprises an order is to be considered an order item. In at least one of the exemplary embodiments, orders may be implemented using well-known data structures that include information about the good or service, including, item name, a unique identifier (such as a SKU or inventory number), description, size, color, price, location, type, status, or the like. An order item may include or be associated with information sufficient to identify the good or service. An order item may include information such as item quality, shipping status, “pick” status (an indication of it being selected or in the process of being selected for order fulfillment), priority, the associated order, or the like. The actual physical good or service represented by the order item data structure, and the order item data structure may be interchangeably described herein as an order item.

The term “picker” as used herein, is used to describe a person or device that may receive information used to locate and/or retrieve an order item(s) that may be part of an order. The item or items may be located in a warehouse or in a physical store. In the situation where the picker is a person, that person may be a customer, an employee of the business (such as an in-store employee), or an agent of the customer or of the business. In at least one embodiment, order information may be electronically provided to the retail store where a picker may be located.

The term “pick,” as used herein, generally refers to the actions of a picker that may include be locating and retrieving an order item(s) that may be part of an order being fulfilled at a physical store or warehouse.

The term “picking data,” as used herein, generally refers to order fulfillment assistance data, such as information and guidance generated by a suitable data processing application and provided to a picker to assist the picker to efficiently locate and retrieve the order item. In at least one embodiment, and as further discussed below, such information may include photographs, video, navigation instructions, item inventory information, map data, images, text instructions, item location information, item availability and inventory information, or the like.

The term “BOPUS,” as used herein is an acronym or abbreviation for “buy online pick up at store.” In at least one embodiment, BOPUS orders may be generated when a consumer makes a purchase or indicates the desire to purchase using any order method described herein, and designates a physical location (e.g., a store or warehouse) for picking up the item. In at least one embodiment, pickers may locate these items in advance of the consumer arriving to retrieve them.

The term “fulfillment server” as used herein generally refers to a data processing element that processes order information to generate fulfillment instructions and related information. In some embodiments, the fulfillment server may be a computing device that is operated by the business. In such situations the fulfillment server may be located in a physical store, in a central data processing location for a group of stores or for the business, or in any other suitable location. In some embodiments, the fulfillment server may be operated by a web service for the benefit of the business (as in a cloud-computing or Software-as-a-Service architecture). The fulfillment server may receive order information and in return access inventory data and date related to one or more of the location, condition, and movement of an item to assist in determining the appropriate manner in which to fulfill the order. One or more options for fulfilling the order may be offered to a customer or employee of the business. Once a fulfillment option is selected, the fulfillment server may generate picking data and route that data to the appropriate user or device (e.g., an in-store kiosk, a desktop computer, a point of sale terminal, a mobile device operated by a store employee or by a customer, etc.).

The term “expedited order item,” or “expedited item,” as used herein refers to an order item that for one reason or another is associated with a limited time for fulfillment. In at least one embodiment, an order item may be expedited if the fulfillment server determines that the business may be unable to fulfill the order item in a timely manner and the promised fulfillment time may be approaching. In at least one embodiment, an order item may be considered expedited if it takes longer than expected to fulfill the item. In at least one embodiment, if the order item is associated with a high priority order (e.g., as determined at order/purchase time), then the order item may enter the system associated with an initial state of being expedited. Further, if the time until the promised fulfillment time is less than a predetermined amount of time, an order item may be designated as expedited for expedited fulfillment.

The term “tag” as used herein refers to a physical element that is associated with an item or items of merchandise (such as a bundle or group of items), or with a structure or location within a physical space, and that is capable of communicating a unique identifier and/or certain data related to the item or items over a wireless (e.g., radio frequency, Wi-Fi, Bluetooth, infrared, optical) communication network. The tag may communicate the data in response to being scanned, interrogated, activated, prompted, powered, or otherwise caused to transfer the data by a process or by the operation of a suitable device. The data transferred/communicated may include one or more of data that identifies the tag (and by inference, identifies the item or the structure), a condition of the item, a location of the item, or other relevant data or information. The tag may be printed directly onto a media, e.g., a paper tag, which may also include other printed information such as text, graphics, pictures, and the like. The tag may be mechanically enclosed in plastic, metal, or the like. One example of a suitable tag is a RFID (radio frequency identification) tag. Another example is a tag that operates to communicate data by use of a NFC (near field communication) mechanism.

Typically, a tag is affixed to an item and then is caused to transfer the data while located at a particular location. The location may be known in an absolute sense or in a relative sense (e.g., (1) the location of the tag and hence the item to which it is affixed is known to be associated with a structure or fixture, the location of which is known because it is fixed in relation to the structures contained in a store, (2) the item tag is scanned or detected by a receiving element positioned at a known location, or (3) the item tag is scanned or detected by one or more receiving elements having a known scan footprint or pattern). In this way, an item having a tag can be wirelessly and uniquely identified to be at a particular location in a physical space (e.g., a fixture in a retail store, a region of a store, or a shelf in a warehouse). The tag may be caused to transfer the data by any suitable manner or process, such as by being passively energized for wireless communication by a hand-held or fixed scanning device that communicates with the tag, by being actively energized by its own power source to wirelessly communicate with a scanning device, or by some hybrid combination of both passive and active components that enables wireless communication with a scanning device. Note that the “scanning device” may be a transceiver or other type of device that is capable of receiving the data transmitted, transferred, or otherwise communicated by the tag. Note also that a tag may be configured to communicate the data to a receiver upon occurrence of a triggering event, such as the expiration of a timer, detection of movement of an item, an instruction or prompt received from another device, etc. A tag or tags in a region of a space may be “polled” by a scanner in order to trigger a response that includes transmission or other form of exchange of data. Similarly, a tag or tags in a region of a space may “broadcast” data in accordance with a schedule, timer, triggering event, etc.

A group of tags may be configured to function as a “network”—in this situation data transmitted by one tag is received by another tag, which then propagates that data (and in some cases, its own identifying or other data) to a third tag. This may continue until identification data for a group of tags within a defined region is in effect “collected” by one tag or control point, from which the set of data is provided to another element. For example, identification data for a set of tags (and hence items with which the tags are associated) that are positioned on the same rack or counter may be transferred to a single tag (such as the one associated with the rack or counter) before being transferred to a collection element. This would enable the single tag associated with the rack or counter to be scanned to collect the desired data, and hence might reduce power consumption and increase the efficiency with which data can be collected. This embodiment of the invention might also be of value in a warehouse where items are stored in areas that are difficult to reach or scan. In such a case, being able to scan a single tag instead of multiple tags would reduce the data collection time and effort.

The term “fulfillment confidence score” as used herein refers to a value that indicates a likelihood that an order item is in suitable condition and is available to be provided to a customer. It represents a measure of the availability of a requested item or items for fulfillment within whatever parameters or restrictions are applicable to the order (such as the fulfillment method, pick-up location, time of delivery, condition of the item, etc.). The fulfillment confidence score may be based on one or more of inventory confidence information, availability confidence information, item lifecycle event history, and location confidence information. The fulfillment confidence score may be generated by a decision process that takes into consideration information about the requested item, its location, lifecycle event or movement history, the customer's order history, the location of the various options for fulfilling the order, etc. The fulfillment confidence score may be generated for one or more scenarios (such as different pick-up locations, different expected conditions of the item, etc.) in order to provide a customer or store employee with options regarding the fulfillment process.

In generating a fulfillment confidence score, various data or information may be determined for an order item with an associated tag, including, but not limited to: (1) the amount of time since the tag was last read; (2) the number of reads of a tag within a certain time frame; (3) the number of reads by different scanners/tag readers in a given time frame; (4) the location of each data transfer by a tag; (5) the total number of order items that can fulfill the sale request that have the same stock keeping unit (SKU) and that are believed to be located in substantially the same location or in an equivalent location; (6) the total number of times that the tag (and by inference the item to which it is attached) is taken to a dressing room; (7) the total number of times that the tag (and by inference the item to which it is attached) was returned after purchase; (8) the number of times that the tag (and by inference the item to which it is attached) was moved between locations; (9) the number of times that the tag (and by inference the item to which it is attached) was moved from a back room to the selling floor of a retail store; (10) the number of times and locations from which a sale request was fulfilled successfully for the order item with the tag; and (11) the number of times and locations from which a sale request was unsuccessfully fulfilled for the order item with the tag. Note that with regards to the factors listed in (6) through (11), data involving other instances of the same (or even a similar) item may also be considered in generating a fulfillment confidence score. For example, by considering multiple instances of an item (or even items that are sufficiently similar to an item), and the customer or store response to those items, it may be possible to determine that any item having a specific SKU is likely to be associated with a lower level of customer acceptance, and hence may be less desirable for use in fulfilling an order than would be suggested by the data relevant to only a specific instance of that item.

In one embodiment, an item having the highest confidence score at a location may be chosen to fulfill a sales request for a customer. In another embodiment, the confidence scores of multiple items at a given location may be aggregated together and used to determine the suitability of that location for fulfilling the sales request for the customer. In this way, if a picker determines that an item chosen for fulfillment is unavailable or not in proper condition to be saleable, another of the same item or type of item may be readily located at or near the same location. Note that the various factors or parameters used to generate a fulfillment confidence score may be assigned weights. Each of these weights, either singly or in combination, may be dynamically adjustable, manually adjustable, heuristically determined, determined by a rule base or other decision process, predetermined, or the like.

The term “retail store” or “physical storefront,” as used herein refers to a physical building where the retailer offers goods and services for sale directly to consumers. At the retail store, the consumer may browse various goods and services, interact with sales agents, or the like, as part of placing their order for an item.

The term “on-line store”, “online store”, or “Internet store,” as used herein refers to a virtual storefront produced using electronic hardware and/or software that represents an Internet presence (such as a web-site), and that enables a customer to review merchandise and services available for purchase, place an order, enter data relevant to the fulfillment process, arrange for payment for the transaction, and perform other operations related to the order. On-line stores include web-based applications, database applications, mobile applications, and the like, and enable consumers to shop on-line for goods and services and/or place orders for goods and services over a network, such as the Internet. In addition, on-line stores may include applications operating on kiosks, mobile devices, and the like, that are physically located within a retail store. Such local applications enable consumers to electronically view offered goods and services and/or generate orders while they are physically located in the retail store.

On-line stores may include applications that may be used by on-site employees (or agents) of a retail store to generate orders for goods and/or services on behalf of consumers that have personally communicated their order to an employee at the retail store. Such on-line stores may also include applications operating on kiosks, mobile devices, and/or fixed-location point-of-sale stations, such as cash registers, and the like. Employees (or agents) of the retail store or employees (or agents) of a remotely located call center and/or customer care center may use an online store to generate orders on behalf of a customer based on information received from the customer via telephone, email, fax, electronic chat services, or the like. An order management platform and/or fulfillment system may receive and/or process orders generated using the one or more types of online stores.

### Exemplary Embodiments

The following describes example embodiments of the invention and provides a basic description of the implementation and operation of those embodiments. This brief description is not intended as an extensive or exhaustive overview of the embodiments, or of the system elements used to implement them. It is not intended to identify key or critical elements, or to delineate or otherwise narrow the scope of the claimed invention.

As recognized by the inventors, a competitive advantage may be gained if a business is able to effectively respond to customers' interests via an expanded merchandise offering, and greater flexibility in ways of placing orders and having those orders fulfilled. For example, the fulfillment process for consumers may be improved if the inventory physically located at both a retailer's physical stores and in its centralized warehouses can be used to fulfill an order originating from either an online store or a retail store. This has the benefit of both increasing the services available to customers, and also reducing the cost of maintaining inventory. However, at present, the differences in operating and administering centralized warehouses for online stores and separate retail stores has made it difficult to efficiently and interchangeably fulfill consumer orders in this manner.

In one embodiment, the invention is directed to a system and associated methods for fulfilling an order from either an online store or a retail store, where the order may have placed using one of several available devices or methods. In some embodiments, an item or items that are part of (or represent the entire) order are associated with a “tag” that may be used to determine one or more of the location, a history of locations and/or movement, a history of movements and/or events or history of events of the item or items within a physical space. In some embodiments the tag is a RFID tag or one that may be used to transfer data by a NFC mechanism.

In one embodiment, the location and/or movement of an item, items, group of items, or other meaningful elements may be determined by reading, scanning, interrogating, activating, or otherwise causing the tag to exchange data with a receiving element. In some embodiments, the data exchanged may be an identifier for the tag (such as an alphanumeric string) that enables a tag attached to a specific item, items, or structure to be associated with other information about that item, items, or structure (such as by correlating the tag identifier with other data stored in a database). In some embodiments, the absolute or relative location of the item, items, or structure may be determined by input of other data, such as knowledge of the location of a structure or element (such as a region, rack, counter, column, case, etc. whose location is known and which is associated with its own tag) and the relationship between the item or items and the structure or element. In some embodiments, the absolute or relative location of the item, items, or structure may be determined by using information about the scan pattern (or patterns) of scanner(s) used to detect a tag attached to an item. In some embodiments, the absolute or relative location of the item, items, or structure may be determined by using information about the fixed location of a scanner (such as in a grid placed in a ceiling or under a floor) that received data from a particular tag.

By acquiring and processing data related to the location and movement of an item or items over time, embodiments of the invention are also capable of providing new services and improved fulfillment capabilities to businesses, business employees, and customers. Some of these new services will now be described, followed by a more detailed description of the elements and implementation details for a system that is capable of providing such services.

In one embodiment, acquired data relating to the location and movement of a requested item (and if relevant, data related to the location, movement, lifecycle, sales, etc. of the same or similar items available in inventory) may be used to generate a fulfillment confidence score for the item. This score may then be used as part of a decision process to determine the fulfillment options offered to a customer and/or to present the customer with information about the likelihood of fulfilling an order within certain constraints, delivery times, etc.

For example, if an item is known to be located at a particular retail store and is in appropriate condition for sale, then even if the same item is available from a warehouse, a customer order may be fulfilled using the item located at the store. Further, if an item is known to be located at a particular retail store and is in appropriate condition for sale, then a customer may be offered the opportunity to pick up the item at the store. The location, movement, lifecycle and other information that is made available enables the invention to provide a greater assurance to the store and to the customer that a requested item will be available to the customer when it is desired. In one embodiment, the customer may be provided with one or more fulfillment options, in addition to information about an expected delivery time if the item is fulfilled from a retail store or from a warehouse. If the condition, size, or style of the item differs between the one at the store and the one in the warehouse, a retailer may want to know and to factor that into their decision regarding which location to use to have an order fulfilled.

In one embodiment, if an item having a tag is determined to be located at a particular location (such as a storage area, holding area, dressing room), then an inventory management (or other business) process may be initiated that corresponds to that particular location. As an example, an item (or order item) located on a hold rack or in a dressing room may be considered unavailable to use to fulfill an order. For another example, an item (or order item) located on a hold rack or in a dressing room for longer than a predetermined time period may initiate a process whereby an employee is sent to relocate the item back to the sales floor of a retail store (thereby making it available to fulfill an order or a different order). Further, an order item located in an order processing area may initiate a process to have an employee ship that item to a customer to fulfill a sales request. Different processes may be initiated in accordance with different locations and conditions, such as how long an item has been in that location. Also, different processes may be initiated in accordance with different types of order items at different locations, such as items having a particular feature, use, timeliness, etc. Further, the movement profile or other data for the item may be updated so that the new data may be used as part of determining a current fulfillment confidence score.

In one embodiment, selection of one or more retail stores to fulfill at least a portion of an order is based in whole or in part on one or more of several considerations or factors, including but not limited to, least cost, least time to deliver the order to the consumer, and a fulfillment confidence score corresponding to an order item (or corresponding to multiple of the same or similar items that are located at the same store or warehouse). In one embodiment, individual order items in a retail store may be sorted and assigned to a picking/pick queue based on a location within the store and a fulfillment confidence score, or the like. In one embodiment, orders comprising multiple order items may be decomposed into individual order items for sorting and queue assignment at one or more retail stores and/or warehouses having order items with associated, fulfillment confidence score(s) that indicate a satisfactory likelihood that the order item is available and in satisfactory condition.

In one embodiment, the fulfillment server may assign order items to one or more pickers from an order item queue. In one embodiment, a picker may be assigned an order item based on a variety of factors including but not limited to, picker preference, picker location (e.g., based on the picker's present location), item location, order item priority, order status, item fulfillment confidence score, or the like. The order items assigned to a picker may be provided in an ordered list so that a path or order is implicitly and/or explicitly defined in the retail store physical space for the picker to follow to efficiently locate the order items.

In one embodiment, the fulfillment server or another data processing element may generate picking data such as a description, map, explicit location identifier (e.g., children's department, carousel #2), a hint, an image, an audio file, a video file, directions, or other information for a picker to use in locating an order item assigned to that picker. The picking data may be provided to the picker using a mobile device (e.g., mobile phone, PDA), point of sale terminal, kiosk, or by any other suitable method or device.

In one embodiment, the fulfillment server may direct the picker to select an item or items prior to an expiration time. In one embodiment, order items that remain “un-picked” at the expiration time may be removed from the order item queue(s) for the retail store. In one embodiment, a separate order management platform that directs each order item for fulfillment by the fulfillment server may resume responsibility for fulfilling the un-picked order items that may have expired and/or been rejected.

In one embodiment, if an order item is located by a picker, then a pick label may be generated and associated with that order item. In one embodiment, the pick label may comprise or reference information that may include, shipping information, consumer data, order item details, additional order information (e.g., multi-item orders), or the like.

In one embodiment, a picker may reject an item for a variety of reasons, including, unavailability (e.g., cannot find the item), condition (e.g., item found but not in suitable condition), or the like. In one embodiment, order items that are rejected (or orders that include one or more rejected items) may be released from being fulfilled by the retail store and instead become the fulfillment responsibility of a separate order management platform. In one embodiment, if a picker rejects an item, then the fulfillment system may check to determine if there is another place in the store in which an instance of the item is located. If another instance exists and its fulfillment confidence score exceeds a certain threshold, then the system may direct the picker to the other location to pick the item. This may be valuable in fulfilling multi-unit orders because it provides an opportunity to maintain the order, and keep it consolidated (instead of rejecting an item and having the order split into multiple shipments from multiple locations). In one embodiment, if one or more order items associated with a multi-item order may be picked but other order items associated with the same multi-item order are rejected, then the multi-item order may be split into two or more orders.

In one embodiment, a customer's order that is placed at a retail store is at least partially fulfilled from a centralized warehouse or a different retail store. In such a case, a separate order management platform may direct the fulfillment server to fulfill at least a portion of the consumer's order from inventory physically located at one or more retail stores or the centralized warehouse. In one embodiment, choosing one or more other retail stores and/or the centralized warehouse to fulfill at least a portion of the order may be based on one or more factors, including but not limited to, least cost or least time to deliver the order to the consumer, or the fulfillment confidence score of an item and/or the aggregated or averaged fulfillment confidence scores of multiple instances of an item when more than one instance exists at a store or location within a store.

### Example of a Suitable Architecture for an Embodiment

As an aid to understanding the implementation and operation of one or more embodiments of the invention, a description of a suitable operating environment (or context) in which those embodiments may be practiced will be presented. It should be noted that the description presented is not meant to be exhaustive (i.e., other elements or functions may be present in an operating environment used to implement or practice an embodiment, nor is it meant to be limiting (i.e., not all of the described elements or functions are required in an operating environment used to implement or practice an embodiment).

As will be described further, the inventors of the embodiments of the invention recognized that by acquiring and processing data related to the location, lifecycle event history, and movement of an item, set of items, or category of items, that new and improved processes could be implemented for purposes of order fulfillment and inventory management. These new and improved processes are expected to provide benefits and value-added services to customers, store employees, and warehouse employees, among others. However, as also recognized by the inventors, the acquisition and processing of the location, event, and movement related data is capable of providing new value-added services that are not possible or not practical without such data.

For example, by knowing the location over time (or at specified times) of an item, and from that data generating a “movement profile” for the item, embodiments of the invention can provide benefits in at least four areas of the operation of a business: (1) order fulfillment; (2) inventory management; (3) customization/personalization of services for a customer; and (4) the development of in-store customer browsing and shopping metrics and analytics.

In some embodiments, these and other benefits may be obtained by performing one or more of the following processes, operations or functions:
(a) Enable the generation of data identifying an item or a tag associated with the item;
(b) Acquire the data identifying the item or a tag associated with the item;
(c) Acquire data sufficient to determine an absolute or relative location of the item;
(d) Process identification and location information for each of multiple items in a physical space;
(e) Over time, generate a profile of the location/movement of an item or items within the space (an item “movement profile”);
Note that in some embodiments, the identification data may be combined with temporal (time related) data to provide a “snapshot” in time of the items within the space—this data may also be processed to provide a time based profile of the items with a space as a function of time and/or time and location. Such a time based profile may provide insights regarding inventory levels as a function of time or season, the interest in specific items or groups of items as a function of time (during lunch hour, after work, etc.) or season, etc.;
(f) Access and process sales information and other data related to transactional events (e.g., identifying data obtained from a point of sale terminal) to determine when an item is sold (a “conversion” event) and associate that sales event with its movement profile, or determine that another type of event occurred and relate that to an item's location and/or movement;
(g) Access marketing or promotional data to determine correlations between that data and the movement profile of an item;
(h) Access data for the initial placement of an item and determine correlations between that data and the movement profile and sale of an item; and
(i) Access demographic data for a customer or segment of customers (based on age, income, etc.) and determine correlations between that data and the movement profile of an item or class of items to better manage inventory and product placement for such items.

A system or device(s) that is intended to be used to implement one or more embodiments of the invention will therefore typically include some combination of elements and processes that are configured to perform one or more of the following functions:
Enable generation of data associated with an item, fixture or structure—this will typically be accomplished by affixing a tag or similar element to an item. The tag will be capable of transferring an identifying string (typically unique, and alphanumeric, numeric, or other) to a receiving device. The identifying string may correspond to the tag or to the item. If corresponding to the tag, then typically a database will be maintained that associates the tag identifier with a specific instance of an item (as opposed to the entire set or group of the same items, which represent multiple instances of the item). Note that the “item” may be merchandise, a package, a set of merchandise, a fixture in the store (such as a display rack, shelf, column), a section of a floor, an entrance to a department or region of a store or warehouse, etc.;
Acquire identifying data for an item or items—this may be done in any suitable way, including but not limited to, (a) scanning an item or structure with a hand held or fixed device, thereby causing a transfer of data, (b) triggering a tag to transfer or transmit identifying data to a receiver (where the “trigger” may be a polling signal, the expiration of a timer that controls the operation of the tag, movement of an item to which the tag is affixed, etc.), or (c) monitoring transmission of data from a tag which is broadcasting the identifying data continually or on a schedule;
Acquire identifying data that is sufficient to enable an absolute and/or relative location to be determined for an item or group of items—typically this may be done by acquiring identifying data for a location, region, structure or fixture and then for an item or items associated with that location, region, structure or fixture (such as the items hanging on a rack or positioned in a particular region of a store). Similarly, this may also be done by acquiring data identifying an item using a scanner or receiver positioned at a known location (such as above an entrance to a dressing room, or attached to a grid in a ceiling) with a known scan pattern. Further, this may also be done by acquiring identifying data using more than a single scanner or receiver having known overlapping or non-overlapping scan patterns (note that if overlapping, then the data may be detected by both scanners, suggesting that the item is located in a region corresponding to the overlap of the scan patterns);
Transfer the acquired data to a suitable data storage and data processing element—typically this may be done using any suitable data communications system or methods, including but not limited to, Wi-Fi, RF, Bluetooth, infrared, optical, the Internet, or local area network technologies. For example a hand held scanner may transmit the data it acquires to a receiving element that is coupled to a computing device using an in-store Wi-Fi network, cellular network, etc. A fixed position scanner may transfer the data it acquires to a computing device using a local area network. An in-store computing device may transfer data to a server via the Internet;
Process the acquired data and other relevant data using a suitably programmed in-store and/or remote data processing element (such as a network server, desktop computer, or other form of computing device) to generate data and/or information that may be used to determine one or more of the location of an item or items, the movement (position) of an item or items over time, the number of times that an item or items have been selected/moved, taken to a dressing room, taken to a specific area of a store, selected with certain other items, purchased, returned, selected but not purchased, taken to a dressing room but not purchased, recommended to a customer and selected, recommended and purchased, recommended and not purchased, etc.;
Process the acquired data and other relevant data using a suitably programmed data processing element to generate data and/or information that may be used by a store employee and/or customer to locate an item or items within a store, department, warehouse, or other space—typically by generating one or more of directions, fulfillment hints, maps, text directions, instructions, etc.;
Provide the data and/or information that may be used by a store employee and/or customer to locate an item or items to the employee and/or customer so that they may locate and presumably purchase or evaluate the item or items.

Note that in many cases there are a plurality of system elements, devices, types of tags, data processing techniques, algorithms, heuristics, rules, etc. that may be used to implement an embodiment of the invention. While certain specific combinations of such elements, devices, types of tags, data processing techniques, algorithms, heuristics, and rules will be described, other combinations are possible and should be considered to fall within the underlying concepts of the invention. Failure to specifically describe a particular combination is not to be interpreted as excluding that combination from consideration as a valid embodiment of the invention.

With regards to (1) order fulfillment, by acquiring and processing item location and/or movement data, one or more embodiments of the invention can perform the following tasks:
(a) Knowing the absolute or relative location of item when a customer is in a store enables a store employee to guide the customer to the item or generate location guidance displays for a mobile or fixed client device used by a store employee and/or customer;
(b) Knowing the absolute or relative location of an item or items enables a store employee to more efficiently be directed to that item or items for purposes of “picking” the item(s) for shipment to, or to set aside for a customer. The location of an item can be used to generate screen displays for a mobile client device used by an employee. Various optimization and/or minimization algorithms, heuristics or rules may be used to construct a picking process/path, with the process or path based at least in part on one or more of the size/weight of items, the priority of items for shipment or delivery, the type of item, the fragility of an item, any special instructions that may apply to an item, etc.;
(c) Knowing the movement profile for an item or items may suggest that the item(s) are not of sufficiently high quality or desirability to use for purposes of fulfillment and should be marked down, discarded, discontinued, removed from inventory for purposes of use in fulfillment for on-line orders, etc. Knowing the movement profile for a group of items may suggest that they are (or are not) commonly purchased together, selected but not purchased, or tried on but not purchased, which may suggest a change to a personalized shopping recommendation, merchandising and store layout decisions, product placement decisions, etc.;
(d) Knowing the movement profile for a class or category of items may suggest (a) increasing demand for such items and impact marketing or product placement decisions, or (b) decreasing demand for such items and therefore cause changes in marketing or product placement decisions;
(e) Generation of a fulfillment confidence score may indicate to a business the likelihood of a desired item being found for fulfillment at a particular store or warehouse, and impact the fulfillment method they recommend to a customer or the fulfillment method they are willing to “guarantee” to a customer; and
(f) Being able to determine the rate of successful fulfillment for a class or category of items may enable a prediction of the rate of successful fulfillment that could be expected for like or similar items. This may impact retailer purchasing decisions (what other items to order from a manufacturer), inventory decisions (what other items to maintain a stock of), or personalized shopping recommendations.

With regards to (2) inventory management, by acquiring and processing item location and/or movement data, one or more embodiments of the invention can perform the following tasks:
(a) Knowing the movement profile for an item, group of items, class of items, or category of items may enable adjustment of inventories to better reflect the number and sizes or styles of items to keep in store and warehouses in order to more quickly and/or less expensively fulfill (i) in-store purchases, (ii) on-line purchases with in-store fulfillment, (iii) remove items selected but not purchased at a desired conversion rate, remove items tried on but not purchased at a desired conversion rate, (4) remove or rotate to mark down an item that has been tried on a certain number of times without being purchased in order to maintain a certain level of quality/freshness of the full price inventory; and
(b) Application of collaborative filtering/recommendation algorithms, heuristics, or rules to data regarding item movement, movement of a category of items, the demographics of customers as related to such movements, the demographics of customers as related to purchases of such items (e.g., conversion rates) may alone or together provide information about customer behavior and generate new strategies for recommending items to customers when the customer is in-store or online, such as:
   1. upselling—providing a personalized shopping recommendation for a customer while in a store based on their identity/demographics and the item selection and movement habits of similar demographics or people having similar tastes in items—note also that since each item selected by a customer in store can be identified, it may be possible to quickly generate a recommendation to that customer with regards to another complementary item, a pair of shoes that would go well with the items they have already selected, a promotional opportunity for the item, etc.;
   2. upselling—providing a personalized shopping recommendation for a customer who orders on-line for pick-up at a store based on their identity/demographics and the item selection and movement habits of similar demographics or people having similar tastes in items;
   3. upselling—providing a personalized shopping recommendation for a customer based on their own purchase history and the correlation of their purchase with other items that are typically purchased (or browsed, selected, tried on, etc.) with that item; and
   4. application of similarity measures (developed using neural networks, statistically valid correlations, etc.) to generate a recommendation of an item that is “like” or “similar” to one selected by a customer but that the customer did not purchase, but that might be of greater interest because of cut, trim, style, etc.

With regards to (3) customization/personalization of services for a customer, by acquiring and processing item location and/or movement data, one or more embodiments of the invention can perform the following tasks. These represent various types of personalized or customized services that may be provided to customers (or prospective customers, and in some cases to vendors) as a result of combining one or more of item (or group of items)/merchandise location, item (or group of items)/merchandise movement, item (or group of items)/merchandise transaction history, customer identity, customer transaction history, and demographic data, along with application of various collaborative filtering, recommendation, statistical analysis, etc. techniques. Non-limiting examples include:
(a) Generate recommendations/personalized shopping suggestions—
   for example, a retailer could offer a special in-store promotion/discount designed to entice an individual customer based on knowing or predicting their tastes (based on those like them, their selection and movement of items, conversion rates) (note that this may or may not be based on detecting their presence near or in a store, or shopping on-line);
(b) Generate targeted marketing, discounts, coupons or other promotional items;
(c) Suggest an item to look at while in a store, provide guidance to finding the item, generate screen displays on a kiosk or a customer's mobile device to assist in locating the item;
(d) Suggest inventory management ideas (such as what levels to maintain in store, at a warehouse, etc.) for store employees based on expected customer interests as evidenced by item selection, item movement, conversion rate for classes of items; and
(e) Assist in development of a marketing plan, store layout, product placement, merchandising strategy or salesperson training for a type of item based on movement history and conversion rates of similar items, and/or demographic aspects of intended target buyers.

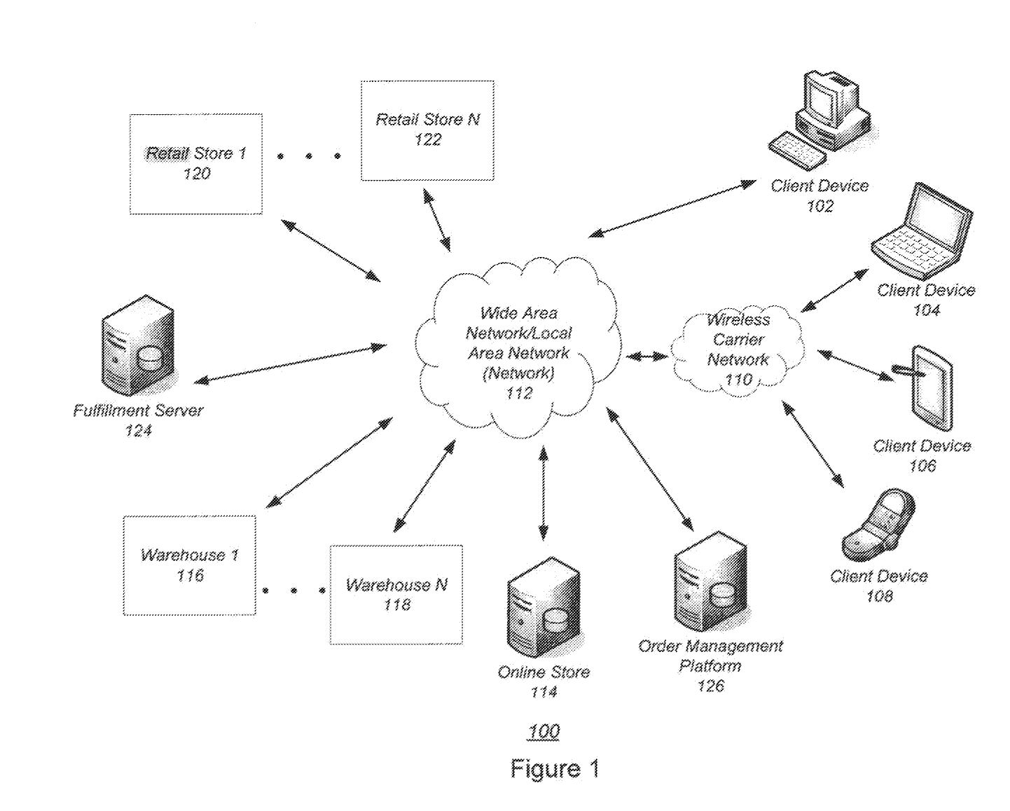

With the preceding discussion as an introduction, a more detailed description of a system and methods that may be used to implement an embodiment of the invention will be presented. FIG. 1 is a block diagram illustrating a system of elements that may be used in whole or in part in implementing an embodiment of the invention. As noted, not all of the components may be required to practice a specific embodiment, and variations in the arrangement and type of the components may be made and still fall within the underlying concepts of the invention. As shown, system 100 of FIG. 1 includes local area networks (“LANs”)/wide area networks (“WANs”)—(network) 112, wireless carrier network 110, client devices 102-108, Online Store Server 114, Warehouses 116-118, Fulfillment Server 124, Order Management Platform 126, and Retail Stores 120-122.

Generally, client devices 104-108 may include virtually any portable computing device capable of receiving and sending a message over a network, such as network 112, wireless carrier network 110, or the like. Thus, client devices 104-108 may include virtually any computing device capable of connecting to another computing device (such as a web server or similar computing or data processing element) and receiving information. Such client devices include but are not limited to, devices such as cellular telephones, smart phones, display pagers, radio frequency (RF) devices, infrared (IR) devices, Personal Digital Assistants (PDA's), handheld computers, laptop computers, wearable computers, tablet computers, integrated devices combining one or more of the preceding devices, or the like. As such, client devices 104-108 typically range widely in terms of capabilities and features. For example, a cell phone may have a numeric keypad and a few lines of monochrome Liquid Crystal Display (LCD) on which only text may be displayed. In another example, a web-enabled mobile device may have a touch sensitive screen, a stylus, and several lines of color LCD in which both text and graphics may be displayed.

Client device 102 may include virtually any computing device capable of communicating over a network to send and receive information, including messaging, accessing web pages, performing various online actions, or the like. The set of such devices may include devices that typically connect to other devices using a wired or wireless communications medium, such as personal computers, multiprocessor systems, microprocessor-based or programmable consumer electronics, network Personal Computers (PCs), or the like.

In one embodiment, at least some of client devices 102-108 may operate over a wired and/or a wireless network. Moreover, one or more of client devices 102-108 may be configured to execute and/or access various computing or data access applications, including for example, a browser, a web-based application, or an application installed on the device.

In one embodiment, one or more of client devices 102-108 may be configured to operate within a business or other entity (such as a store, or data processing center for a store or stores) to perform a variety of services for the business or other entity. For example, one or more of client devices 102-108 may be configured to operate as a web server, an accounting server, a production server, an inventory server, or the like. However, note that client devices 102-108 are not constrained to being configured to provide these services and may also be employed, for example, as an end-user computing node or data access device. Further, it should be recognized that a greater or fewer number of client devices may be included within a system such as described herein, and embodiments of the invention are therefore not limited to a certain number or type of client devices employed.

A web-enabled client device may include a browser application that is configured to send requests for web pages (typically by means of requesting that a web server provide a web page corresponding to a specified URL), and receive web pages, web-based messages, or the like. The browser application may be configured to receive and display graphics, text, multimedia, or the like, employing any suitable web-based language, including wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SGML), Hypertext Markup Language (HTML), eXtensible Markup Language (XML), HTML5, or the like, to display and send a message or web page. In one embodiment, a user of the client device may employ the browser application to perform various actions over a network.

Client devices 102-108 may also include at least one other client application that is configured to receive and/or send data, including budgeting and forecasting information, between the client device and another computing device. The client application(s) may include a capability to provide requests and/or receive data relating to identifying, finding, and fulfilling orders. In some embodiments, the client application may employ processes such as described below in conjunction with the figures to perform at least some of its actions.

In one embodiment, client devices 102-108 may also be used by consumers to access Online Store 114. In one embodiment, a consumer may user one of client devices 102-108 to purchase goods and/or services by accessing and interacting with Online Store 114.

Wireless carrier network 110 may be configured to couple client devices 104-108 and its components with network 112, typically by use of a gateway server which operates to permit messages and data to be exchanged between devices coupled to network 110 and other devices (such as web servers) coupled to network 112. Wireless carrier network 110 may include any of a variety of wireless sub-networks that may overlay stand-alone ad-hoc networks, or the like, to provide an infrastructure-oriented connection for client devices 104-108. Such sub-networks may include mesh networks, Wireless LAN (WLAN) networks, cellular networks, or the like.

Wireless carrier network 110 may further include an autonomous system of terminals, gateways, routers, or the like connected by wireless radio links, or the like. These connectors may be configured to move freely and randomly and organize themselves arbitrarily, such that the topology of wireless network 110 may change rapidly.

Wireless carrier network 110 may further employ one or more access technologies, including 2nd (2G), 3rd (3G), 4th (4G), 5th (5G) generation radio access for cellular systems, WLAN, WiMax, Wireless Router (WR) mesh, or the like. Access technologies such as 2G, 3G, 4G, 5G, and future access networks may enable wide area coverage for mobile devices, such as client devices 104-108 with various degrees of mobility. For example, wireless carrier network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), High Speed Downlink Packet Access (HSDPA), Long Term Evolution (LTE), or the like. In essence, wireless carrier network 110 may include any wireless communication mechanism by which information may travel between client devices 104-108 and another computing device, network, or the like.

Network(s) 112 (e.g., the Internet in conjunction with a local network) may be configured to couple network devices with other computing devices, including, fulfillment server 124, client device(s) 102, and through wireless carrier network 110 to client devices 104-108. Network 112 may be enabled to employ any suitable form of communication media for purposes of storing, accessing, and transferring data or messages from one electronic device to another. Note that network 112 can include the Internet in addition to local area networks (LANs), wide area networks (WANs), direct connections (such as through a universal serial bus (USB) port), other forms of computer-readable media, or any combination thereof.

On an interconnected set of LANs, including those based on differing architectures and protocols, a router may be used to act as a link between LANs, enabling messages to be sent from one to another. In addition, communication links within LANs typically include twisted wire pair, coaxial cable, or optical fiber, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. For example, various Internet Protocols (IP), Open Systems Interconnection (OSI) architectures, and/or other communication protocols, architectures, models, and/or standards, may also be employed within network 112 and wireless carrier network 110. Furthermore, remote computers and other related electronic devices may be remotely connected to either LANs or WANs via a modem and temporary telephone link. In general, network 112 represents and includes any communication methods and infrastructure by which information may travel between computing devices.

Communication media typically includes one or more of computer-readable instructions, data structures, program modules, or other transport mechanism and includes any information delivery channel or media. By way of example, communication media includes wired media such as twisted pair, coaxial cable, fiber optics, wave guides, and other wired media and wireless media such as acoustic, RF, infrared, optical, and other wireless media.

Warehouses 116-118 may include any suitable facility, structure, space, etc. usable for fulfilling orders received from consumers. Warehouses 116-118 may be designed to store and organize items so that orders for customers may be efficiently fulfilled (e.g., “picked” and prepared for delivery) when received. In one embodiment, Warehouses 116-118 may be coupled with network 112 over which they may exchange messages and data with one or more of Fulfillment Server 124, Order Management Platform 126, Online Store 114, Retail Stores 120-122, client devices 102-108, other warehouses, or the like.

Retail Stores 120-122 may include any suitable facility, structure, space, etc. usable for selling items to consumers. In one embodiment, Retail Stores 120-122 may be organized to optimize the shopping experience of customers that look for and purchase items in person. In one embodiment, Retail Stores 120-122 may be coupled with network 112 over which they may exchange messages and data with one or more of Fulfillment Server 124, Order Management Platform 126, Online Store 114, Warehouses 116-118, client devices 102-108, other retail stores, or the like.

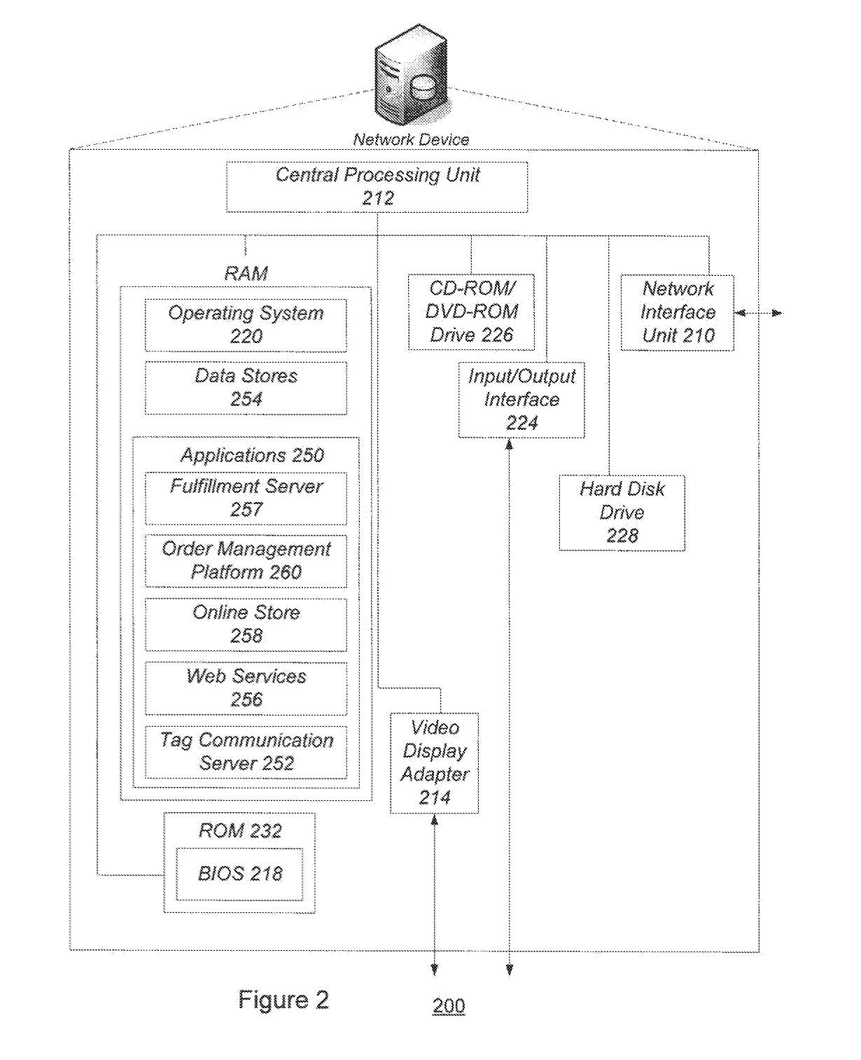

Order Management Platform 126 may include any suitable network device usable to provide order management services, such as network device 200 of FIG. 2. In one embodiment, Order Management Platform 126 may employ various methods, processes, or operations to enable routing and/or order fulfillment functions between and among Online Store 114, Warehouses 116-118, Retail stores 120-122, and Fulfillment Server 124. In accordance with embodiments of the invention, Order Management Platform 126 may be configured to route orders and/or implement order fulfillment policies based on various factors, including but not limited to, inventory availability, delivery costs, the condition of merchandise, customer profile data, store employee inputs, customer demographics, or the like.

Fulfillment Server 124 may include any suitable network device usable to provide fulfillment services, such as network device 200 of FIG. 2. In one embodiment, Fulfillment Server 124 may employ various methods, processes, or operations to enable routing and/or order fulfillment functions, such as to receive orders assigned to be fulfilled at a retail store (including order items that may have been ordered using Online Store 114).

Systems and devices that may function in whole or in part as one or more of Online Store 114, Fulfillment Server 124, or Order Management Platform 126 include, but are not limited to personal computers (PCs), desktop computers, multiprocessor systems, microprocessor-based or programmable consumer electronics devices, network PCs, server devices, network appliances, or the like.

Note that although each of Online Store 114, Fulfillment Server 124, or Order Management Platform 126 is illustrated as a single network device in FIG. 1, embodiments of the invention are not so limited. Thus, in one embodiment, one or more of Online Store 114, Fulfillment Server 124, or Order Management Platform 126 may represent a plurality of coupled and/or uncoupled network devices. For example, in one embodiment, the functions and operations of one or more of Online Store 114, Fulfillment Server 124, or Order Management Platform 126 may be distributed over a plurality of network devices and/or implemented using a cloud-based architecture (e.g., in which the functions and operations of Fulfillment Server 124 are provided as a web service in a single or in a multi-tenant environment).

Thus, certain of the functions, operations, and services of a system that is configured to implement an embodiment of the invention may be distributed over a single or multiple data processing devices, may be located on-site (e.g., co-located with a store, data processing center for a business, etc.) or in “the cloud”, may be a dedicated architecture for use by a single entity, or may be made available to multiple entities as part of a multi-tenant architecture. In such a multi-tenant architecture, a provider of one or more of the online store, fulfillment server, or order management server services may provide those services to multiple corporate users, where each such corporate user may represent a different company, sales channel, organization, etc.

Moreover, each of Online Store 114, Fulfillment Server 124, or Order Management Platform 126 is not limited to a particular configuration. Thus, each may operate using a master/slave approach over a plurality of network devices, within a cluster, as part of a peer-to-peer architecture, and/or as part of any other suitable architecture. Thus, each of Online Store 114, Fulfillment Server 124, or Order Management Platform 126 is not to be construed as being limited to a single environment, and other configurations, and architectures are also envisaged.

### Example of a Suitable Network Device for an Embodiment

FIG. 2 is a functional block diagram illustrating elements of a network device or server that may be used in whole or in part in implementing an embodiment of the invention. Network device 200 may include more or fewer components than those shown. The components shown, however, are believed sufficient to disclose an illustrative embodiment for practicing the invention. Network device 200 may represent, for example, one or more of Online Store 114, Fulfillment Server 124, or Order Management Platform 126 of FIG. 1.

Exemplary network device 200 includes central processing unit (CPU) 212, video display adapter 214, and a data storage element or elements, all coupled to (and hence capable of communication and data exchange with each other via) bus 222. The data storage element(s) generally includes random access memory (RAM) 216, read only memory (ROM) 232, and one or more permanent data storage devices, such as hard disk drive 228 (which may take the form of, or be used in combination with a tape drive, optical drive, flash drive, solid state drive, or floppy disk drive). The data storage element(s) (typically RAM 216) operate to store operating system 220 for controlling the operation of network device 200. Any general-purpose operating system may be employed. Basic input/output system (BIOS) 218 may be used for controlling the low-level operation of network device 200.

As illustrated in FIG. 2, network device 200 can communicate with the Internet, or another suitable communications network (such as a local area network), via network interface unit 210, which is typically configured to utilize various communication protocols, including the TCP/IP protocol. Network interface unit 210 is sometimes referred to as a network interface card (NIC). Network device 200 also typically includes input/output interface 224 for enabling communication with external devices, such as a headset, or other input or output devices (such as a keyboard, touch screen, etc.) not shown in FIG. 2. Input/output interface 224 may utilize one or more communication technologies, such as USB, infrared, Bluetooth™, or the like.

The data storage element or elements as described above illustrate a type of computer-readable media, namely computer-readable data storage media. Computer-readable data storage media may include volatile, nonvolatile, removable, and non-removable media implemented in any method or technology for storage of information, such as computer readable instructions, data structures, program modules, or other data. Examples of computer readable data storage media include RAM, ROM, Electronically Erasable Programmable Read-Only Memory (EEPROM), flash memory or other memory technology, Compact Disc Read-Only Memory (CD-ROM), digital versatile disks (DVD) or other optical storage, magnetic cassettes, magnetic tape, magnetic disk storage or other magnetic storage devices, or any other physical medium which can be used to store the desired information and which can be accessed by a suitable computing device.

Data stores 254 may include a database, text, spreadsheet, folder, file, document, or the like, one or more of which may be configured and used to maintain and store various order item information, item images, inventory information, shipping data, consumer preferences and information, or the like. Data stores 254 may further include software instructions, program code, data, algorithms, data processing rules, decision heuristics, or the like. Such software instructions, program code, data, algorithms, data processing rules, decision heuristics, or the like may be used by a processor, such as central processing unit (CPU) 212 to perform (in whole or in part) operations, methods, techniques or functions that are implemented as part of an embodiment of the invention. In one embodiment, at least some of data and/or instructions stored in data stores 254 may also be stored on another element of network device 200, including, but not limited to CD-ROM/DVD-Rom 226, hard disk drive 228, or other computer-readable data storage medium or device that is incorporated in network device 200 or that is accessible by network device 200 over, for example, network interface unit 210.

The data storage element(s) may store program code and data other than that stored in data stores 254. For example, one or more software applications 250 in the form of sets of executable instructions may be stored in the data storage element(s) and executed by CPU 212 under the control of operating system 220. Examples of software application programs 250 may include transcoders, schedulers, calendars, database programs, word processing programs, Hypertext Transfer Protocol (HTTP) programs, customizable user interface programs, IPSec applications, encryption programs, security programs, SMS message servers, IM message servers, email servers, account managers, and so forth.

The data storage element(s) may also include executable instructions used to implement one or more of the functions or operations of a fulfillment server 257, an order management platform 260, an online store application or server 258, a merchandise tag communications application or server 252, or a web services application or server 256. By this is meant that network device 200 may be configured to operate as a fulfillment server, an online store, an order management platform, or another element of an overall system. In such a capacity, network element 200 may include software instructions/code that when executed enable network element 200 to function as a “host” for an application that is used by other elements of the system. Similarly, network element 200 may include software instructions/code that when executed enable network element 200 to function as a client or other device that is able to interact with a server that “hosts” an application (such as a server configured to host an online store application, fulfillment server application, etc.).

Web services 256 represent one or more of a variety of services that are utilized to provide content over a network to another computing device. Web services 256 may include for example, a web server, a File Transfer Protocol (FTP) server, a database server, a content server, or the like. Web services 256 may provide content over a network using any of a variety of formats, including, but not limited to WAP, HDML, WML, SGML, HTML, XML, compact HTML (cHTML), extensible (xHTML), HTML 5.0, or the like. Web services may be accessed via a suitable API (e.g., a RESTful API) or other suitable mechanism.

In one embodiment, web services 256 may provide a user interface for accessing and manipulating data in a data store, such as data stores 254, or the like. Web services may provide such an interface and any other capabilities as part, of a single tenant or multi-tenant architecture. In another embodiment, web services 256 may provide a user interface or other means for interacting with a fulfillment server application 257 (located within network element 200 or within a different but similar element), where that application may enable a user to access and/or otherwise review order items, orders, picking data, item information, or the like, that may be provided via a network connection to network device 200. In one embodiment, fulfillment server application 257 may enable users to receive orders, view order items, allocate items to a picker, generate picking data, prioritize fulfillment of items, or the like. In one embodiment, fulfillment server application 257 may enable delivery of orders by determining delivery and/or shipping information for completed orders.

In one embodiment, online store application 258 may enable consumers to browse goods and service using a web browser, mobile device application, tablet application, or the like. In one embodiment, online store application 258 may generate web pages or graphical user interfaces that may include images and text descriptions of goods and services that may be offered for sale. In one embodiment, if a consumer places an order using the online store application 258, then an order may be generated, processed, and/or routed for fulfillment by employing a suitable order management platform and/or fulfillment server. In one embodiment, employees of a retail store may place orders on behalf of consumers using online store application 258.

In one embodiment, order management platform application 260 may be utilized to perform or assist in performing functions related to the management and administration of orders, including, routing orders and/or order fulfillment operations between and among Online Store 114, Warehouses 116-118, Retail stores 120-122, and Fulfillment Server 124 of FIG. 1. Order Management Platform 260 may be employed to route orders and/or order fulfillment based on various factors, including, inventory availability, delivery costs, customer preferences, store employee inputs, or the like. In one embodiment, an order management platform may receive portions of orders that may be rejected by a fulfillment server. In one embodiment, portions of orders determined to be non-saleable for whatever reason may be directed to an order management platform by a fulfillment server.

In one embodiment, tag communications application or server 252 may receive and process information for items of merchandise associated with a uniquely identifiable tag. The data and/or information may be provided by a plurality of sources, including at least one of a client device, a portable tag scanning device, a fixed tag scanning device, a movable tag scanning device, or the like. The tag information may also be associated with location information, so that an item that is associated with a tag is both identifiable and known to be at a particular absolute or relative location within a physical space (such as a retail store and/or a warehouse).

### Example of a Suitable Client Device for an Embodiment

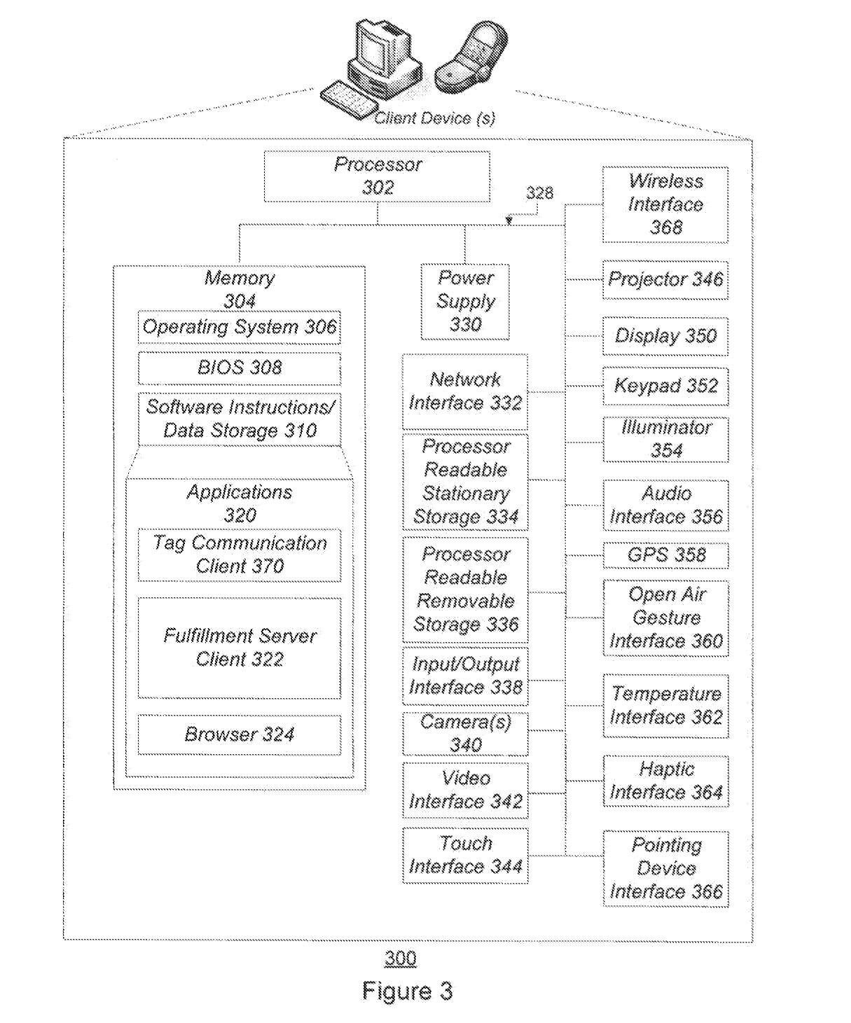

FIG. 3 is a functional block diagram illustrating elements of a client device that may be used in whole or in part in implementing an embodiment of the invention. Client device 300 may represent, for example, at least one embodiment of client devices 102-108 shown in FIG. 1 (e.g., a desktop computer, a PDA, a mobile phone, a laptop computer, a tablet computer, etc.). Note that not all of the elements to be described are required for a suitable client device that is capable of operating as part of the inventive system or is capable of implementing one or more aspects of an embodiment of the invention.

In one embodiment, client device 300 includes processor 302 in communication with memory 304 via bus 328. Processor 302 may be any suitable element that is capable of being configured to execute a set of instructions, typically by programming the processor with the software instructions. Examples of suitable implementations of processor 302 include (but are not limited to) microprocessors, central processing units (CPU), microcontrollers, programmable elements, etc. Memory 304 is typically a form of electronic storage that is used to store software instructions for an operating system and applications, and data used for calculations and other operations.

Depending on the type of client device and its implementation, client device 300 may also include one or more of power supply 330, network interface 332, audio interface 356, display 350, keypad 352, illuminator 354, video interface 342, input/output interface 338, haptic interface 364, global positioning systems (GPS) receiver 358, wireless communications interface 368, open air gesture interface 360, temperature interface 362, camera(s) 340, projector 346, pointing device interface 366, processor-readable stationary storage 334, and processor-readable removable storage 336. Power supply 330 provides power to client device 300. A rechargeable or non-rechargeable battery may be used to provide power. The power may also be provided by an external power source, such as an AC adapter or a powered docking cradle that supplements and/or recharges the battery. Although not shown, a gyroscope and/or accelerometer may be employed within client device 300 to measure and/or maintain an orientation of device 300.

Client device 300 may optionally communicate with a base station (not shown), or directly with another computing device. Network interface 332 includes circuitry for coupling client device 300 to one or more networks, and is capable of enabling communications and data transfer using one or more communication protocols and technologies including, but not limited to, protocols and technologies that implement any portion of the Open Systems Interconnection (OSI) model for mobile communication (GSM), code division multiple access (CDMA), time division multiple access (TDMA), user datagram protocol (UDP), transmission control protocol/internet protocol (TCP/IP), Short Message Service (SMS), Multimedia Messaging Service (MMS), general packet radio service (GPRS), WAP, ultra wide band (UWB), IEEE 802.16 Worldwide Interoperability for Microwave Access (WiMax), Session Initiation Protocol/Real-time Transport Protocol (SIP/RTP), or any of a variety of other wired or wireless communication protocols. Network interface 332 is sometimes referred to as a transceiver, transceiving device, or network interface card (NIC).

Audio interface 356 is configured to enable the production and reception of audio signals, such as the sound of a human voice. For example, audio interface 356 may be coupled to a speaker and microphone (not shown) to enable telecommunication with others and/or generate an audio acknowledgement for some action. A microphone coupled to audio interface 356 can also be used for input to (or control of) one or more functions of client device 300, e.g., using voice recognition, detecting touch based on sound, and the like.

Display 350 may be a liquid crystal display (LCD), gas plasma, electronic ink, light emitting diode (LED), Organic LED (OLED) or any other type of light reflective or light transmissive display that can be used with a client device. Display 350 may also include a touch interface 344 configured to receive input from an object such as a stylus or a digit from a human hand, and may use resistive, capacitive, surface acoustic wave (SAW), infrared, radar, or other technologies to sense touch and/or gestures. Projector 346 may be a remote handheld projector or an integrated projector that is capable of projecting an image on a remote wall or any other reflective object, such as a remote screen.

Video interface 342 may be configured to capture video images, such as a still photo, a video segment, an infrared video, or the like. For example, video interface 342 may be coupled to a digital video camera, a web-camera, or the like. Video interface 342 may comprise a lens, an image sensor, and other electronics. Image sensors may include a complementary metal-oxide-semiconductor (CMOS) integrated circuit, charge-coupled device (CCD), or any other integrated circuit capable of sensing light.

Keypad 352 may comprise any input device configured to receive input from a user. For example, keypad 352 may include a push button numeric dial, a keyboard, and any other suitable input mechanisms. Keypad 352 may include command buttons that are associated with selecting and sending images. Illuminator 354 may provide a status indication and/or provide light. Illuminator 354 may remain active for specific periods of time or in response to events. For example, when illuminator 354 is active, it may backlight the buttons on keypad 352 and stay on while the device is powered. Also, illuminator 354 may backlight these buttons in various patterns when particular actions are performed. Illuminator 354 may also cause light sources positioned within a transparent or translucent case of the client device to illuminate in response to certain actions.

Client device 300 may also comprise input/output interface 338 configured for communicating with external peripheral devices or other computing devices, such as mobile devices and network devices. The peripheral devices may include an audio headset, display screen glasses, remote speaker system, remote speaker and microphone system, and the like. Input/output interface 338 may utilize one or more technologies, such as Universal Serial Bus (USB), Infrared, WiFi, WiMax, Bluetooth™, and the like. Haptic interface 364 is configured to provide tactile feedback to a user of the client device. For example, haptic interface 364 may be employed to vibrate a client device 300 in a particular in response to an incoming call or message. Temperature interface 362 may be used to provide a temperature measurement input and/or a temperature changing output to a user of client device 300. Open air gesture interface 360 may sense a physical gesture of a user of client device 300, for example, by using single or stereo video cameras, radar, a gyroscopic sensor inside a device held or worn by the user, or the like. Camera 340 may be used to track physical eye movements of a user of client device 300.

GPS transceiver 358 may be used to determine the physical coordinates of client device 300 on the surface of the Earth, and typically outputs a location as latitude and longitude values. GPS transceiver 358 may employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine or more precisely determine the physical location of client device 300 on the surface of the Earth. In one embodiment, client device 300 may, through other components, acquire information that may be employed to determine a physical location of the device, including for example, a Media Access Control (MAC) address, IP address, and the like.

Human interface components may include peripheral devices that are physically separate from client device 300, allowing for remote input to and/or output from client device 300. For example, information routed as described herein through human interface components such as display 350 or keyboard 352 can instead or in addition be routed through network interface 332 to appropriate human interface components located remotely from the client device. Examples of such remotely located peripheral human interface components include, but are not limited to, audio devices, pointing devices, keypads, displays, cameras, projectors, and the like. These peripheral components may communicate over a Pico Network such as Bluetooth™, Zigbee™ and the like. One non-limiting example of a client device with such peripheral human interface components is a wearable computing device, which might include a remote projector along with one or more cameras that remotely communicate with a separately located client device to sense a user's gestures toward portions of an image projected by the projector onto a reflected surface such as a wall or the user's hand.

A client device may include a browser application 324 that is configured to request, receive, display and to send web pages, web-based messages, graphics, text, multimedia, and the like. The client device's browser application may employ virtually any programming language, including wireless application protocol messages (WAP), and the like. In at least one embodiment, the browser application may be enabled to employ Handheld Device Markup Language (HDML), Wireless Markup Language (WML), WMLScript, JavaScript, Standard Generalized Markup Language (SGML), Hypertext Markup Language (HTML), eXtensible Markup Language (XML), HTML5, or the like. Note that the client device may also (or instead) include an application that performs one or more of the functions or processes of a browser, where such an application is typically represented as a set of instructions (such as Java, Objective C, etc.) that may be executed by a suitably programmed processor.

Memory 304 may include any suitable form of electronic memory, including but not limited to Random Access Memory (RAM), Read-Only Memory (ROM), and/or other types of memory. Memory 304 represents an example of a computer-readable storage media or element for the storage of information, such as computer-readable instructions, data structures, application program modules or other data. Memory 304 typically stores a basic input/output system (BIOS) 308 for controlling low-level functions or operations of client device 300. The memory also typically stores an operating system 306 for controlling other operations of client device 300. It will be appreciated that operating system 306 may represent a general-purpose operating system such as a version of UNIX, or LINUX™, Microsoft Corporation's Windows™, Apple® OS, or a specialized mobile device operating system such as Windows Mobile™, Apple® iOS, Android™, or the Symbian® operating system. The operating system may include, or interface with a Java virtual machine module that enables control of hardware components and/or operating system operations via Java application programs.

Memory 304 further typically includes one or more data storage elements 310, which can be utilized by client device 300 to store, among other things, executable software instructions in the form of applications 320 and/or other data. For example, data storage 310 may be used to store information that describes various functional and/or operating capabilities of client device 300. Such information may be provided to another device based on one of a variety of events, including being sent as part of a header during a communication, sent upon receipt of a request, or the like. Data storage 310 may also be used to store social networking information and/or user profile data including address books, buddy lists, aliases, or the like.

As noted, data storage 310 may include program code, data, algorithms, and the like, for use by a suitably programmed processor (such as processor 302) to perform various functions, operations, processes, etc. In one embodiment, at least some of the instructions or data stored in data storage 310 might also be stored in another component of client device 300, including, but not limited to, non-transitory processor-readable removable storage 336 or processor-readable stationary storage 334. Depending on the applications being executed by client device 300, data storage 310 may include, for example, order item data, retail department information, order item images, customer preference data, inventory data, fulfillment related data, or the like.

Applications 320 may include computer executable instructions which, when executed by a suitably programmed processor enable client device 300 to transmit, receive, and/or otherwise process instructions and data. Applications 320 may include, for example, Fulfillment Server Client 322, Tag Communication Client 370, and Browser 324. Other examples of application programs that may be included in Applications 320 include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. Tag communication client 370 may be configured to collect and process information obtained from tags associated with merchandise and/or structures that is provided via wireless interface 368. A scanner or other element capable of acquiring data from a tag (not shown) may be integrated with or connected to client device 300. In one embodiment, location information for a scanned tag may be determined by tag communication client 370 from information provided by wireless interface 368, which may be further supplemented with other relevant location information (e.g., Wi-Fi triangulation information, GPS information, Bluetooth information, etc.).

### General Description of a Suitable Operating Environment of an Embodiment

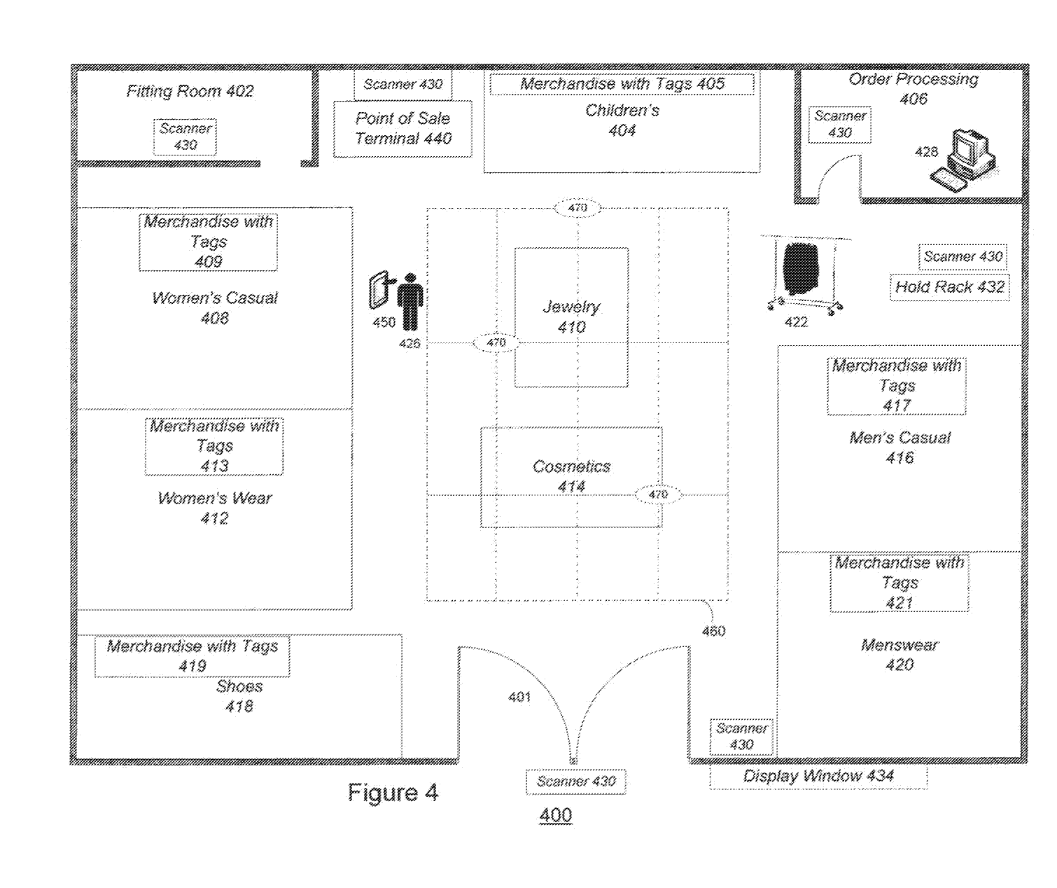

FIG. 4 is a diagram illustrating certain elements of an environment (in this case, a retail store) and of the inventive system that may be used in whole or in part in implementing an embodiment of the invention. Although the following description presents the practice of an embodiment of the invention within the context of a retail store or section of such a store, it should be understood that this is for purposes of explanation and does not represent a limitation. An embodiment of the invention may be implemented and practiced in any suitable location or space, including but not limited to, a store, a warehouse, an open space, a floor of a building, an open or enclosed lot, a mall, a mobile or transportable space/enclosure, etc.

In one embodiment, retail store 400 may contain goods for sale to the general public. In one embodiment, goods for sale in retail store 400 may be arranged or classified based on a variety of factors including: type, quality, the intended customers for the goods, or the like. Likewise, in one embodiment, physical areas of retail store 400 may be arranged into departments based on various factors that may include, type of good, season (e.g., Summer, Spring, Fall, or Winter), holidays, target customers, and the like. Note that goods may fall into multiple overlapping classifications.

In the exemplary arrangement shown in FIG. 4, retail store 400 may include departments that offer specialized goods including: Children's 404, Women's Casual 408, Jewelry 410, Women's Wear 412, Cosmetics 414, Men's Casual 416, Shoes 418, Menswear 420, or the like. Also, particular display areas for goods, such as display window 434 may be provided. The number, type, and name of departments in a retail store may vary and are not limited to the departments and/or arrangement depicted in the figure. Note that each such department will typically (although is not required to) contain merchandise that may be purchased by a customer, with at least some such merchandise being affixed with (or otherwise associated with) a tag of the type described herein that may be used to identify the item of merchandise and enable a determination of its location and/or movement. Such “tagged” merchandise is depicted as elements 405, 409, 413, 417, 419, and 421 in FIG. 4.

Retail store 400 may include other areas and/or locations dedicated to purposes other than displaying goods for sale, such as fitting room 402, order processing 406, merchandise hold rack 432, or the like. Fitting room 402 may be an area where a customer may try on a garment before deciding whether to make a purchase. Goods may be moved and/or temporarily stored in non-selling areas of a retail store such as fitting room(s) 402, storage areas (not shown), or the like. Retail store 400 will typically include one or more fixed or mobile point of sale terminals 440 (or similar devices) at which a store employee may assist a customer to make a purchase. In these non-selling areas, fixed scanner(s) 430 may be positioned to detect when goods are physically moved into and out of these areas. Also, fixed scanner 430 may be placed in one or more display areas, such as display window 434. Additionally, fixed scanner 430 may be located at or near external doors 401 of retail store 400 to monitor when goods exit or enter the retail store. Also, although not shown, movable scanners may be located at temporary kiosks, seasonal displays, and the like, to uniquely identify items at these temporary locations. Further, movable scanners may be incorporated into hand held mobile devices 450 (such as a PDA, mobile phone, etc.) that may be used by store or warehouse employees (or customers) to collect data related to the location and movement of merchandise items.

In one embodiment, a scanner or other device for detecting, receiving data from, or otherwise interacting with a tag affixed to an item or fixture may be positioned at a known location under the floor of a display area or overhead in a ceiling or sub-ceiling of a display area. An example is depicted as element 460 in the figure. Element 460 may be a grid of known dimensions and position to which is attached one or more scanners 470. Scanners 470 or other devices used to obtain data from a tag or tags may be positioned so that they detect tags placed below them or within a known beam pattern (such as an angle or solid angle of “viewing”). By knowing the beam pattern (field of view) and sensitivity, along with the location of the scanning device, the position of any tag detected can typically be narrowed down sufficiently to enable satisfactory determination of the location of the item or fixture to which the tag is affixed. Note that knowing the beam pattern(s) of more than one scanner (and their overlapping regions) may enable localization of a tag more efficiently when the tag is detected by more than one scanning device. An arrangement such as element 460 and scanners 470 may be used to detect items independently of, or in cooperation with, other scanners or detectors (such as hand held, fixed position, etc.). This may be particularly useful in regions in which other tag detection or interrogation methods would be obtrusive.

In one embodiment, certain order processing 406 functions may be performed by an in-store computing device 428, although they may also be performed by a network device that is located remotely from the store. Device 428 may be configured to receive orders originating from on-line purchases that are made using Online Store 114 of FIG. 1 (note that an instance of Online Store 114 may be accessible to a customer via an in-store kiosk, point of sale terminal, or hand held device operated by a store employee or by the customer). In one embodiment, orders may be directed to a retail store and hence to order processing operation 406 from Fulfillment Server 124 and/or Order Management Platform 126.

In a typical scenario, merchandise will be tagged and inventoried. A unique tag identifier (such as a string of alphanumeric characters) may be associated with each tag and hence with the item of merchandise to which a tag is affixed (by for example, scanning in the SKU or item identifier and linking it to the tag identifier in a database). A tagged item of merchandise may then be scanned or otherwise caused to transfer the identifier of the tag to a receiver or other device at a later time. In order to determine the location of a tagged item, a tag affixed to a known structure or store fixture may be scanned and in some way associated with the merchandise or a group of merchandise. In this way the individual items in a department or location within the store may be associated with their present location. Similarly, if the scan pattern (such as the antenna lobes) of a scanning device is known, then it may be possible to determine the direction and approximate distance of an item from the scanning device and hence obtain an approximation to its location. Further, if a scanner is located in a fixed (and presumably known) position, then when an item tag identifier is detected, it is presumably because that item is located nearby the scanner or within a region associated with the scanner (such as a dressing room, point of sale terminal, warehouse, region of a store, etc.).

Note that an item or items may be subject to being moved around a store, store department, warehouse, loading/shipping dock, etc. as a result of the actions of customers, store employees, or vendors. Therefore the location of an item determined by a scan may change over time. This may permit scan data for an item over time to be used to construct a movement profile for that item, where such a profile indicates how a particular item's location changes over that time. It also permits a store employee or customer to obtain knowledge of where an item is most likely to be located when it is desired to use the item to make a purchase or fulfill an order.

For example, suppose that order processing device 428 and/or fulfillment server 124 receives an order for an order item for a customer from an on-line store (or on-line store application executing on a mobile device, kiosk, etc.). The operator of the on-line store may then determine if the item is available from a warehouse for fulfillment. The operator of the on-line store may also determine if the item is available from one or more retail store locations, and if so, which of those retail stores is most desirable for purposes of fulfilling the order (such as being located relatively near to the customer, having the item with a relatively high fulfillment confidence score, etc.). The online store may then offer the customer the option of having the item shipped to them by mail or package delivery, delivered by courier service, or picked up at one or more retail store locations. The fulfillment server (or another element of the architecture of FIG. 1 or FIG. 4) may assist the customer to decide which option to use for receiving the item. This may involve consideration of one or more of shipping times, total cost, the availability of a variety of the items (in different styles, colors, sizes) at a retail store, the urgency with which the item is desired by the customer, etc. If the customer should decide that they prefer to pick up the item at a retail store, then the customer may be presented with a list of retail stores from which to select the one they desire to go to. Once the customer indicates a retail store from which they wish to pick up the item, Order Management Platform 126 and/or Fulfillment Server 124 of FIG. 1 (or another similar element) may send a message or order confirmation to the selected retail store. This will alert that store that a customer is planning to visit in person to select an item.

Order processing device 428 (or another suitable element that is located within the store or is accessible over a network) may then access data that indicates the last known location of the item within the store. In some cases, a store employee may be requested to conduct a more current scan to confirm the item's location. In some cases, order processing device 428 (or another suitable element) may generate one or more fulfillment hints for the item. As described herein, such “hints” may include one or more of text instructions, maps, images, overlays, audio instructions, etc., to more efficiently enable a store employee or the customer to locate the item.

One or more of the hints may then be provided to a store employee and/or the customer by display on a kiosk or point of sale terminal, transmission to a hand held device (such as a PDA, tablet computer, or mobile phone), or another suitable method. The hint or hints may then be used by the customer or by a “picker” (e.g., as depicted by element 426) to locate the item. Picker 426 may use a suitable hand held device, such as depicted by element 450, to access the hints. If the item is found, Picker 426 may enter a confirmation of finding the item into device 450. Note that the item may be located within a department of the store on a sales floor, in a stockroom, or on a display fixture within the store (such as depicted by element 422 in FIG. 4). Note further that because display fixture 422 may also have a tag affixed to it, the location of an item on that fixture can be established by scanning the fixture tag and then the items located on the fixture.

In a situation in which a picker or customer has more than one item to collect, the inventive system may provide a suggested picking or collection order based on consideration of one or more of the size of an item, the weight of an item, the fragileness of an item, the location of an item, the location of an item relative to another item or to an exit, the number of instances of an item within a store or department, the individual or aggregate fulfillment confidence scores for an item or items, etc. Such a suggested picking or collection plan may be based on a minimization algorithm designed to minimize the expected retrieval time or distance traveled (e.g., least squares, traveling salesman, etc.), an optimization algorithm designed to optimize several variables (e.g., time, distance, weight carried, etc.), a set of rules, a suitable heuristic based on perceived benefit to a certain order, etc.

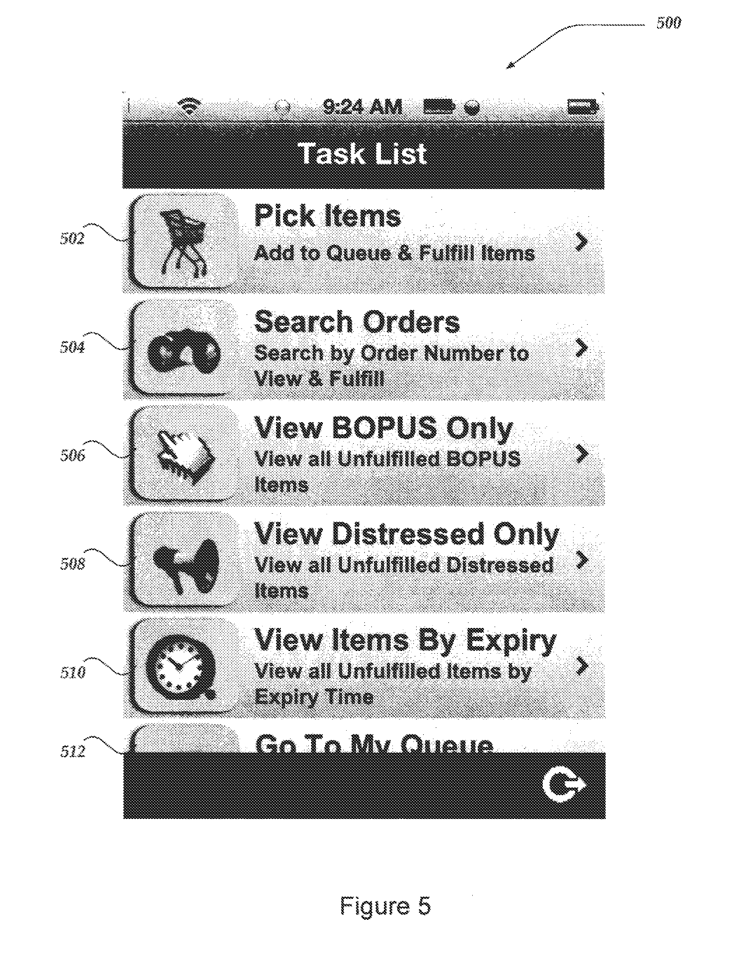

The store employee, warehouse employee, or customer may be further assisted in selecting or picking a set of items by a user interface provided on a hand held or other device that provides the user with a set of displays for efficient location and retrieval of items. For example, the displays may provide a menu that permits an employee to select an order to pick first, which constraints or conditions to fulfill first or be guided by in determining an ordering of items to pick, track the total items in an order, send a message confirming that an item was “picked”, send a message requesting further assistance in locating an item, etc. (note that examples of possible displays will be described in greater detail with reference to FIGS. 5-7).

As has been described, embodiments of the invention are directed to a system and associated methods for determining a location of an item or items using a “tag” that is affixed to the an item. The tag may be of any suitable form and operate by any suitable mechanism or technology (e.g., RFID or NFC) to enable transfer of some form of identifying data to a receiving device (e.g., a scanner). The transferred data may be used to identify the tag and by virtue of that information, to identify the item to which it is affixed (typically by reference to a database of previously collected data regarding the identity of a tag affixed to each of a set of known items). By also collecting identifying information from a region of a store, or a structure or fixture in a store on which the item is placed or arranged, the location of the item may also be determined. As described, this may enable the generation of information to assist an employee or customer in locating and selecting the item. This provides an enhanced order fulfillment process that may be used to fulfill an online order in a store.

However, as recognized by the inventors, information regarding the location of an item or items may also be used for other purposes. By collecting information about the location of an item over time, a “movement profile” of the item within the store may be determined. The movement data may be supplemented by information about “events” in the lifecycle of an item or group of items (such as sales, returns, transfers), information about the number of times the item is located near or within certain areas of the store (such as a dressing room, point of sale terminal, or specific department (indicating, perhaps an interest on the part of a customer in combining the item with an item from another department), etc. By combining this “movement profile” of the item with other data (e.g., lifecycle events, marketing plans, sales numbers, demographic data about a customer or class of customers, sales conversion numbers for the item, etc.), new and improved services that benefit a business, store employee, warehouse employee, or customer may be developed. Note that in addition to collecting and processing identification and location data for an item or items, aggregate data for classes or categories of items may be processed to provide a movement profile and other information for a class of items. This may enable the development of enhanced business information regarding customers' interest in certain types of items, conversion rates for certain types of items, the types of items that are most likely to be selected together and/or tried on by a customer, etc.

### Exemplary Illustrative Screen Displays

FIGS. 5, 6, and 7 are illustrations of exemplary screen displays that may be displayed on a hand held device, kiosk, point of sale terminal, computer display screen or any other suitable device for the purpose of assisting a store or warehouse employee to “pick” a set of items for one or more customers, and that may be used in whole or in part in implementing an embodiment of the invention. It is noted that these are provided for purposes of illustration and that the actual user interface(s) used as part of implementing an embodiment of the invention may include displays that include or lack any of the elements shown. One of ordinary skill in the art will appreciate that such a user interface may include additional or fewer display screens than those shown in the included figures. For example, additional screens (not shown) may be used to perform administrative functions, such as user/picker login, password maintenance, user status, or the like. Also, in one embodiment, additional screens for performing picking and other functions may be included depending on workflow configuration, or the like.

FIG. 5 depicts for one embodiment, task list 500 for a mobile fulfillment application that may be executed on a hand held or other form of client device (such as that described with reference to FIG. 3). In one embodiment, the task list may be divided into high level tasks that may be undertaken by a picker (e.g., a store or warehouse employee). In one embodiment, such tasks may include, pick items 502, Search Orders 504, View BOPUS Only 506, View Distressed Only 508 (where “distressed” may refer to items having a limited time for fulfillment, such as an associated expiration date by which picking, shipping, or delivery needs to occur), View Items by Expiry 510 (such as ordered by the expiration or fulfillment time limit), Go To My Queue 512, or the like.

In one embodiment, pick items 502, may enable a picker to access a user interface that enables the picker to select order items from the retail store fulfill queue. In one embodiment, the picker may have access and/or visibility to items that may not be selected by another picker. Also, in one embodiment, the order items accessible and/or visible to the picker may be determined in part by factors such as, type of good or service, location of the picker within the retail store, location of good within the retail store, supervisor/administrator preference, number of order items already in picker's pick queue, or the like. In this way the workload placed on each picker at any time may be adjusted or re-balanced in accordance with one or more factors related to the current environment of the store or warehouse, the picking queue for the picker or for a group of pickers, the urgency of certain items in terms of their need for fulfillment, etc.

In one embodiment, search orders 504 may enable a picker to access a user interface that enables the picker to search for orders and order items. In one embodiment, a user interface form may be presented to the picker to enable the picker to enter search criteria. In one embodiment, View BOPUS Only 506, may enable a picker to access a user interface that enables the picker to view a list of orders and/or order items that may be designated as BOPUS orders. In one embodiment, View Distressed Only 508, may enable a picker to access a user interface that enables the picker to view a list of orders and/or order items that may be designated as distressed orders (such as those requiring more immediate fulfillment). In one embodiment, View Items by Expiry 510, may enable a picker to access a user interface that enables the picker to view a list of orders and/or order items that may be displayed in a sort order based on the expiry of the order and/or order item. In one embodiment, Go To My Queue 512, may enable a picker to access a user interface that enables the picker to view a list of orders and/or order items that may be assigned to the picker's pick queue.

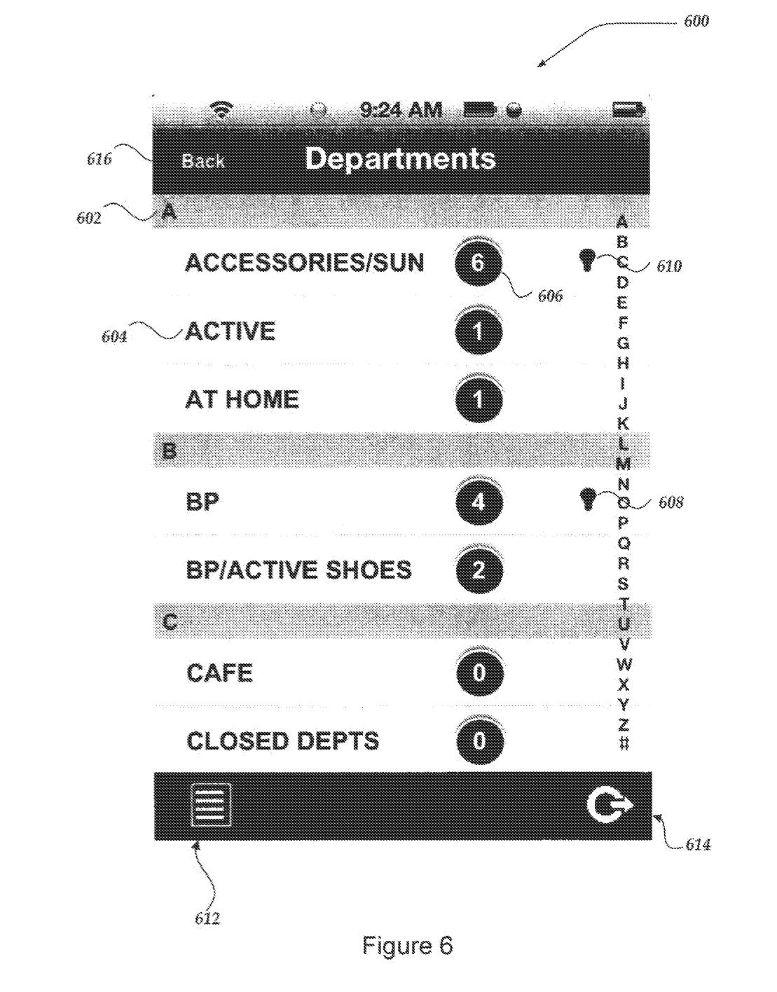

FIG. 6 depicts an exemplary department screen 600. In one embodiment, department screen 600 may illustrate the departments of a retail store in sorted order (e.g., alphabetically). In one embodiment, divider 602 may be employed to divide the department names into sections that correspond to the Alphabet. In one embodiment, within each section the title and/or descriptive name 604 of the department(s) may be displayed. In one embodiment, indicator 606 may display the number of order items that may be available for picking that are associated with a given department. For example, in one embodiment, indicator 606 shows that six items may be available for picking in the “accessories/sun” department. In one embodiment, the number displayed may indicate the number of currently unassigned order items that may be available for picking (i.e. currently unassigned to a picker). In one embodiment, a distress marker 608 and 610 may be displayed for one or more departments indicating that there may be distressed order items in the department. In one embodiment, the toolbar button, task list 612, may be selected to navigate back to a top-level task list. In one embodiment, toolbar button logout 614 may be configured to log a user out of the system and return to a login screen. Further, in one embodiment, back button 616 may be employed to navigate back to the previous application screen.

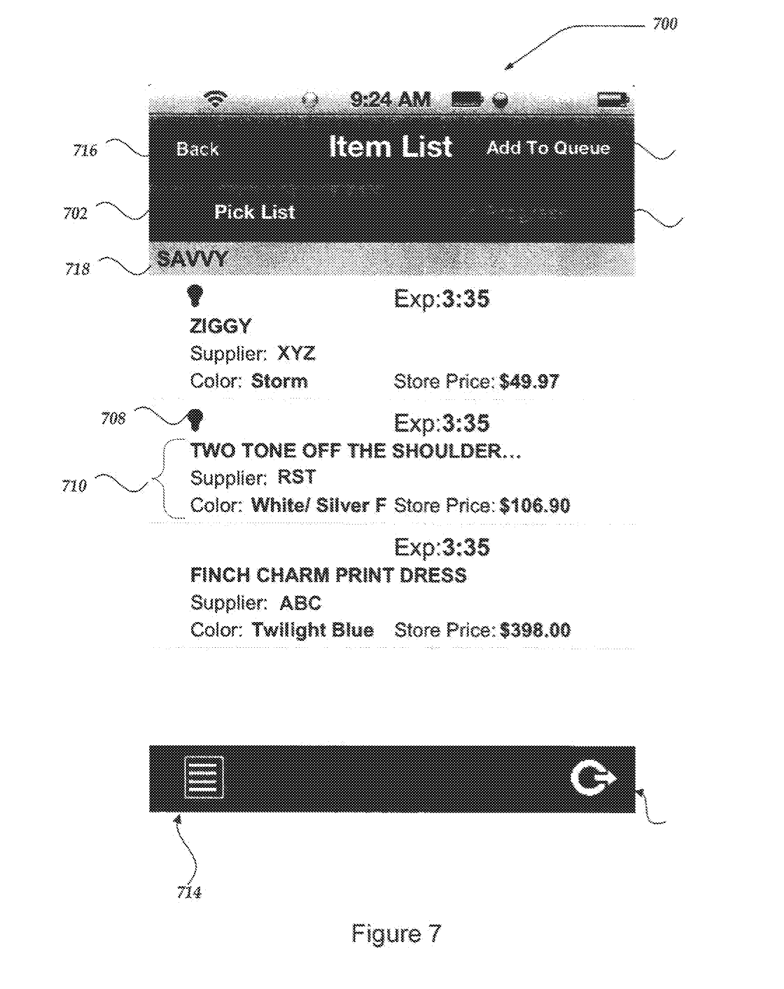

FIG. 7 depicts an exemplary department level order item list screen 700. In one embodiment, the fulfillment server may be employed to display order items associated with a particular department that may be ready for picking. In one embodiment, the department order item list may be toggled to show items requiring picking that may need attention from the picker. In one embodiment, if the picker selects the “add to queue” button 704, the currently selected item from the pick list may be assigned to the picker and added to the picker's queue. In one embodiment, the fulfillment server may be employed to list the order items for a department where the locating and picking may be in progress (not shown). In one embodiment, by selecting the “in progress” button 706 the display may change to show the order items in the department that may be assigned to one or more picker queues. In one embodiment, each picker may view the items in the picker's individual queue. In one embodiment, the fulfillment server may display “in progress” order items belonging to other pickers as well as the “in progress” order items assigned to the picker using the application. In one embodiment, the fulfillment server may grant a picker privileges to view and/or edit the pick queues of other pickers. In one embodiment, these privileges may be associated with the user/picker and stored in database, configuration file, or the like.

In one embodiment, distress marker 708 may be activated indicating that an order item may be a distressed item. In one embodiment, an item list may include order item information 710 that may comprise one or more of a title, description, and/or name of the order item (e.g., Two-tone off the shoulder blouse), the supplier and/or maker of the item (e.g., RST), color (e.g., White/Silver), price (e.g., $106.90), expiration time (e.g., 3:35), location (the department in which the item is expected to be found), or the like. In one embodiment, the kind of information displayed may vary depending on the type of order item displayed. In one embodiment, department name 718 may be displayed prominently on the screen. In one embodiment, similar and/or consistent with other screens, the toolbar button, task list 714, may be selected to navigate back to a top-level task list. In one embodiment, toolbar button logout 712 may be configured to log a user out of the system and return to a login screen. In one embodiment, back button 716 may be employed to navigate back to the previous application screen.

Note that once a picker (or in some cases, a customer) selects an item or items to “pick”, they may be provided with fulfillment hints in the form of directions, maps, clues, a diagram of the store and its departments, graphic overlays, etc. that define a path to take in order to locate the item(s). These “hints” may be displayed on a screen of a hand held device, kiosk, or point of sale terminal, be projected onto a suitable screen, produce audible sounds indicating a relative closeness to an item (similar to a sonar “beep” or Geiger counter click), etc. Further, as noted the order in which a set of items is “picked” and hence the pick path presented to a store employee or customer may depend on one or more factors, including but not limited to the number of items, the size of an item, the weight of an item, the fragileness of an item, the value of an item, etc. The order and hence picking path may be constructed so as to minimize some factor or to provide a balance between one or more factors.

In one embodiment, the order in which items are displayed to a store employee (a picker) may be based on an expiration time for an order. For example, order items with the least amount time remaining for fulfillment may be sorted to display at the top of the list. In one embodiment, if an order item is located by a picker, the picker may scan/enter the SKU or other data into a field of a user interface display. This may be used to confirm that the item has been “picked” and also used for purposes of updating inventory data, etc. In one embodiment, if an item is found but not at the expected location, then a store employee may scan the item and an identifier for a structure or store region in which the item was found. This may be used to update the data used to determine the location of the item and generate the fulfillment hints.

In one embodiment, order processing device 428 may enable a store employee to interact, review, configure, and/or operate aspects of a fulfillment server. In one embodiment, orders may be relayed to device 428 from a central order dispatching system that may allocate orders for fulfillment among retail stores and/or warehouses. In one embodiment, device 428 may include a wireless/Wi-Fi network transceiver for communicating with devices used by pickers or customers. Device 428 may be configured to receive information from a variety of fixed, portable, and movable scanners located in a store.

In one embodiment, a user may utilize device 428 to review the orders that have be assigned to the retail store for fulfillment. In one embodiment, order status, order expiry/duration, order priority, or the like, may be reviewed and/or modified using device 428. A user may use device 428 to review order item queues, update item hint information, re-assign order items among the queues and/or pickers, or the like.

In one embodiment, device 428 may be located in other than order processing 406. Device 428 may be implemented using more than one network and/or local client device that may be located inside store 400 and/or located remote from store 400 (e.g., a regional administration or data processing center). In one embodiment, the pickers may be autonomous or semi-autonomous robotic devices, human beings, or some combination of robotic devices and human beings.

In one embodiment, the location of a picker may be monitored and/or tracked by device 428 or another suitable device or system element. In one embodiment, a mobile client device being used by a picker may include a local area tracking mechanism. In one embodiment, a picker may use an individual picker tracker component that may be embedded, attached to, or carried by the picker. For example, a picker tracker may be embedded or attached to a security badge, or similar item. If local tracking information regarding a picker is available, then device 428 may notify the picker if they are near order items that may be ready for picking.

### Fulfillment Confidence Score

As noted, in one embodiment a value termed a “fulfillment confidence score” may be used as part of a process of one or more of (a) determining whether to use a particular item to fulfill an order, (b) determining the optimal sequence in which a set of items should be picked, or (c) determining the fulfillment options to provide to a customer. The score may be expressed as a number or set of numbers, or along with other parameters. The score may be determined based on a weighted sum of multiple terms, an average of multiple values, a sum of multiple terms, or by any other suitable method or process. The weights and/or terms may be selected based on a customer profile (thereby emphasizing those criteria of most importance to a particular customer), on an available inventory (thereby adjusting a fulfillment decision based on inventory levels or changes in inventory levels), delivery schedules (thereby adjusting a fulfillment decision based on availability of delivery or time of year), or any other suitable factor or factors.

Note that in one embodiment, the fulfillment confidence score of an item may include consideration of one or more of its present location, its most recent location(s), specific item lifecycle events (sale, removal from sales floor, return after being sold, etc.). In one embodiment, the fulfillment confidence score of an item may not include consideration of its current location and instead be based on prior locations and events.

The value of a parameter of a fulfillment confidence score (or of the total score itself) may be altered (i.e., incremented or decremented) based on the occurrence or non-occurrence of an event or other factor. Such an event or factor may involve the condition of the item, its present or previous location, its movement profile, its expected desirability as evidenced by other data, the occurrence or non-occurrence of a sale, the occurrence or non-occurrence of an article being tried on, etc. The two Tables below show how a particular event (“Event”) or item location (“Location”) might alter a confidence score (“Output”). Note that the Tables are presented as examples and that other Events and the associated impacts on a fulfillment confidence score may be implemented in an embodiment of the invention.

| Event | Output |
|---|---|
| An item is sold | Item is marked not fulfillable |
| An item is returned | Item remains not fulfillable and has a |
| | confidence score of zero |
| Item passes a QA check and | Item has it's fulfillability and |
| has a quality level assigned | confidence score updated |
| High quality | High Quality |
| Medium quality | Fulfillable = Y |
| Fair quality | Confidence = 100 |
| | Medium Quality |
| | Fulfillable = Y |
| | Confidence = 50 |
| | Fair Quality |
| | Fulfillable = N |
| | Confidence = 0 |
| An item has a hold placed for it | Update fulfillability to N |
| A hold expires for an item | Fulfillability remains at N |
| | If the item also remains in a |
| | hold area, fire an alert that an |
| | expired hold item is still in the hold |
| | area |
| An item has its hold removed | Fulfillability becomes Y |
| An item has a transfer created for it | Fulfillability becomes N |
| An item is marked as not fulfillable | Fulfillability becomes N |
| | Confidence = 0 |
| An item is fulfilled | Fulfillability becomes N |
| An order exists at a store for an | Order is rejected and |
| item which has its fulfillability | rescheduled for routing |
| moved to N and there are no | to another store |
| other suitable items at that store. | |

| Location | Output |
|---|---|
| Item is moved to the dressing room | Confidence − 10 |
| | Fulfillability N |
| | Items become more worn each time they are |
| | tried on, we infer that an item was tried on when |
| | it is moved to the dressing room |
| Item is placed on a hold bar | Fulfillability N |
| | Items are not fulfillable when they are on the |
| | hold bar |
| A regular Item leaves it's home location | Confidence − 5 |
| | Items become a bit more worn each time they |
| | leave their home location |
| A durable item leaves its home location | No change |
| A sensitive item leaves its home location | Confidence − 10 |
| Item arrives at alterations | Fulfillability N |
| Item is placed in a ‘hot pick location’ | Confidence + 100 |
| | We prefer to pick from hot pick locations over |
| | all other store locations |
| An item moves past ‘exit’ scanners | Fulfillability N |
| Item arrives at a location which improves its | Confidence + X |
| confidence score | Some locations will be easier to pick from and |
| | therefore we can increase our confidence that |
| | we will be able to successfully fulfill an item |
| Item arrives at a location which reduces its | Confidence − X |
| confidence score | Some locations will be harder to pick from and |
| | therefore we decrease our confidence that we |
| | will be able to successfully fulfill an item |
| An item is moved to the non-sell area | Fulfillability becomes N |
| Item undergoes a simple movement that has no | Fulfillability and confidence remain |
| effect on confidence or fulfillability | unchanged, but an entry is made in the |
| | movement profile to record the change in |
| | location |

In addition, below is a Table that summarizes some of the rules or heuristics that may be applied to information regarding the location and/or movement of an item or items. These represent examples of what information or conclusion may be drawn by having access to the type of data that is provided by an embodiment of the invention. Such rules or heuristics may provide valuable insight into marketing, promotional, inventory, or other functions of a business. They may also be used as part of a process that involves adjusting a confidence score or other measure of the desirability of a particular item.

| Rules and analytics | Use/Value of this information |
|---|---|
| An item spends the majority of its time at a | That location is defined as that item's “home |
| given location | location”. Once known, can detect when the |
| | item leaves it's home location |
| An item has many locations in its movement | Items that have more movements in their |
| history | history are more likely to be shop worn and will |
| | be less desirable for fulfillment |
| | Items that have more movements in their |
| | history have had more customer interest - may |
| | indicate relatively high customer interest in a |
| | style, color, etc. |
| | Can infer that movements that happened close |
| | in time together were performed by the same |
| | customer. Each of these temporally close |
| | movements can be chained together to |
| | understand the shopping behavior of a |
| | customer. |
| An item leaves its home location | Can count this as carting/browsing activity, |
| | when an item leaves its home location can infer |
| | that a customer was interested in it |
| An item is taken to the dressing room | Can count this as another carting/browsing |
| | activity. |
| An item is purchased | This is the final step in the conversion funnel - |
| | can evaluate this relative to the other |
| | browsing/carting events to determine the |
| | performance of the item, and/or the items home |
| | location |
| An item taken to the dressing room is left there | Can count this as an ‘abandonment’ - can also |
| and not involved in a purchase | look for trends and determine if there might be |
| | fit or other quality issues with the item |
| A location has a multitude of items | Confidence increased for the location - more |
| | likely to find a fulfillable instance of an item if |
| | there are multiple items in that location |
| An item is detected on a hold bar, but no valid | Generate an alert |
| hold exists for that item | |
| An item is detected at a hot pick location | Prefer that item for order fulfillment/routing |
| | over other of the same item at different |
| | location(s) |
| A brand new customer has placed at order for | Prefer items with only the highest confidence |
| an item | scores for fulfillment, ignore other routing |
| | logic. |
| The items at a particular location(s) within the | Increase the preference for fulfilling from |
| store have a greater rate of successful | locations that have higher rates of successful |
| fulfillment | fulfillments |
| The items at particular location(s) within a store | Decrease the preference for fulfilling from |
| have a lower rate of successful fulfillments | locations that have lower rates of successful |
| | fulfillments |
| An item in fulfilled status exits through the | Update the item status to “shipped” |
| loading doors of the delivery room | |
| An item exits the store through a public exterior | Infer that this item was stolen, generate an alert |
| door without being associated to a sale | and remove the item from consideration for |
| transaction | future fulfillment |
| A single instance of a Sku exists at a store | Calculate a confidence score for “Sku location” |
| | using the combination of Sku instance and |
| | location |
| | Use the score to help determine |
| | picking location and pick paths in the store |
| | Use this score as the Sku store confidence score |
| | to help inform order routing decisions (as |
| | described previously) |
| Multiple instances of a Sku exist at a store in | Calculate a confidence score for each “Sku |
| one or more locations | location” by aggregating the confidence scores |
| | of all the instances of a Sku at each location |
| | Use this score to help determine |
| | picking locations and pick paths in the store |
| | Aggregate the “Sku location” confidence scores |
| | to create a “Sku store” confidence score and use |
| | this score to help inform routing decisions (as |
| | previously described) |

Additional details regarding the use of one or more of location, movement, lifecycle event, and item identity data (such as a SKU or UPC code) are given below. In some use cases these details provide additional information to that presented in the Tables and represent additional embodiments of the invention.

### Using the Confidence Score to Influence Routing of Order to a Store

Stores can fall under one of several scenarios:

(a) A single fulfillable instance of a given sku at a store
(b) Multiple fulfillable instances of a sku at a given store in a single location within the store
(c) Multiple fulfillable instances of a sku at a given store in multiple locations within the store
(d) One or more instances of a sku in a preferred location within a store (e.g., a hot pick bar)

If there is a single available instance of a SKU at a store, then the confidence score for that SKU is to be surfaced for use when determining routing preference.

If there are multiple available instances of a SKU in a single location at a store, then an amalgamated confidence score could be created, for each location that contains one or more sku instance one could:

Sum all of the confidence scores together
Average the confidence scores
Create a composite score whereby the highest score is summed with a fraction of the lesser confidence scores. (i.e. 95+(80*0.1)+60 (*.1)=109)

If there are multiple locations within the store, repeat the above steps to calculate the confidence for each location and then create an amalgamated confidence score that represents the combined confidences of all the locations within the store.

Item confidence score->location confidence score->store confidence score

The calculated store confidence score may be incorporated into existing routing logic and be used to inform the best store to route the order to for fulfillment

If there are one or more instances of a sku in a preferred location within a store, then route the order to that location, regardless of confidence or other factors.

Example of a preferred location: hot pick bar, from which we want to fulfill orders first.

### Using the Confidence Score to Determine a Pick Path Within a Store and to Calculate a Location Confidence Value

If an order has arrived at a store it can fall under one of 3 conditions:

A single instance of a given sku at a store

Advise the fulfiller to pick this sku
If the sku is not found or is found to be in non-sellable condition make that sku unavailable at that location and reschedule the order for routing to another location

Multiple instances of a given sku at a store, determine the most confident location sku in one of the following ways:

Direct the fulfiller to pick the location of the most preferred sku instance
Direct the fulfiller to the location with the greatest number of instances of the given sku
Direct the fulfiller to the location with the greatest amalgamated confidence score, amalgamate the scores in the possible ways:
Sum all the confidence scores together
Average the confidence scores
Create a composite score whereby the highest score is summed with a fraction of the lesser confidence scores. (i.e. 95+(80*0.1)+60(*.1)=109)

One or more instances of a sku in a preferred location

Direct the fulfiller to the preferred location regardless of confidence score of this or other locations

### If the SKU Cannot be Found in the Location Provided

If a SKU is not found in the location provided, it's fulfillability should be set to N, should trigger a cycle count

If there are no other locations available, the item should be rejected and rescheduled for routing to another store
if it is a multi-unit order with other units at the store, it should automatically direct the user to the next most confident location
If it is a single unit order, it should direct the user to the next most confident location if that location exceeds x threshold
Otherwise the unit should be rejected and rescheduled for routing to another store

### If the SKU is Found, but is not in Suitable Condition

Same as above, but do not trigger a cycle count

### When the SKU Instance is Found

Detect the picker's location when the item is or ask the picker to indicate the location where they found the item

i. If the location matches the one that the system had provided, then set the fulfillability of the SKU to N.
ii. If the location detected or indicated by the picker does not match, then add the location indicated by the picker to the known field of view of the scanner and denote the original field of view as inaccurate

If a certain field of view has been noted as inaccurate for a certain scanner, then that information can be used to lower the confidence that the area is actually covered by the scanner or reader

### Display a “Heat Map” to Users Looking for Item(s)

Provided a user has indicated an interest in locating a particular SKU, or group of SKUs, display a map of the store floor plan. Overlay on top of this map points for each location that a SKU instance currently resides in. An item is said to currently reside in a location when that location is the last entry in its movement profile, and it has a confidence of greater than zero

This information can be made available in merchandise search, for users online looking at BOPUS items, to customers who bring a wish list to the store, for items they have added to their shopping bag online, to users who are doing fulfillment activities or otherwise looking for an item or certain class of items (blue polo shirts), etc.

The indicator(s) on the map may visually indicate the confidence score for that location. If desired, may display just the areas with the highest confidence score. For a customer facing implementation (as opposed to a store employee/picker) may display just the locations that are customer accessible.

### Correlate Real-Time Movements to Infer Customer Browsing and Shopping Behavior

This information will be more reliable in the situation in which the tag scanners/readers are continuously scanning and/or the tags are broadcasting data. Such information may be used for one or more of the following purposes:
1. If in a given period of time (e.g., 5 seconds) only one item comes into the field of view of a scanner, it can be assumed that the item's movement is not associated with that of another item. This provides the following possible benefits:
We can assume that the item is on its own and is being moved by either a customer or an employee;
We can review the history of movements and infer shopping behavior.
2. If an item is in the field of view of a fixture/rack then a hard aisle, then a point of sale scanner, and then an exit scanner, we can assume that a customer picked the item from the fixture, made their way to the checkout, and then out the door

Can examine the time intervals to infer the time spent shopping, in transaction etc. and use those to improve service.
3. If an item was scanned by a point of sale scanner and sold, how long was it since each of the previous reads? If the reads happened within a given amount of time (e.g., 5 minutes) we can infer that the movements were all made by the same person and create a chain of the movements to understand the shopping behavior.
4. Can infer how long was spent by item/customer at each location by examining the time delta between when the item first came into view of the scanner and when the item left the view of the scanner.
5. Can detect when an item leaves the field of view of a scanner and determine that the item has been removed from its current location. Can determine how frequently items leave their home location. Can determine the home location as the field of view under which the item has spent the greatest portion of its lifecycle.
6. Can combine one or more of the behaviors listed above to understand the browse and purchase behavior of items and customers. For example, (a) if an item leaves it's home location we can count that as carting activity, (b) items that have a lower relative amount of movement from a home location may be considered to have low browse activity, (c) if an item enters the field of view of a dressing room we can count that as try-on activity, (d) if an item enters the field of view of a point of sale scanner we can count that as a purchase attempt, (e) if an item becomes part of a transaction we can count that as a purchase.

If the above actions occur for multiple items simultaneously, we can infer that the items were moved, browsed or purchased together. If several items are scanned in the same locations at the same time throughout the store, we can infer the shopping pattern of the customer carrying those items. If some of the actions above occur, but a purchase is not completed, we can infer that the customer was interested in purchasing the item, but barriers existed that either dissuaded or prevented the customer from completing a transaction. If an item has a high rate of entering the dressing room and then is not purchased that could let us infer there are fit issues with the product and encourage contact with the manufacturer.

If two or more items (items a and b) are frequently moved together, taken to the dressing room together, or purchased together we can surmise that customers who are interested in item A may also be interested in item B. This information can be input into a recommendation engine or other form of collaborative filtering process as training data. In addition, we can feed these correlations into our existing recommendation engines to make their recommendations more robust and better tailored for in-store customers. We can provide a recommendation to customers who have one of the items in their possession (e.g., in a dressing room, at the checkout, or while walking around the floor).

### Detect When Items Have a Lack of Activity in their Movement Profile

If an item has not been scanned in a relatively long time by any reader, then such a situation may indicate:
(a) a damaged tag
(b) inventory shrinkage (a stolen item)
(c) suggest a lower our confidence score.

If an item has been scanned by a reader in the same location, without new movement activity for a relatively long time, that may suggest:
(a) a bad read (orphaned tag)
(b) stale merchandise
(c) a problem with merchandise presentation (e.g., an item in a poor location for selling, such as a back room instead of a sales floor)
(d) inventory integrity (for back stock or secured items).

### Detect When “Home” Locations have a Greater or Less than Average Amount of Movement or Sales Activity

As described above, an item's home location is the location where it has spent the majority of its time. We can calculate the number of items that “live” in a given location by enumerating all the items that have that location as their home location.

Then, for a given period (e.g., a day or a week) calculate the following for each home location in the store (a location which one or more items has as its home location):
The number of times an item from that home location left the location (left the field of view of the scanner that covers that location);
The number of times an item was returned to the location (returned to the field of view that covered that location);
The number of times an item from that location was taken to a dressing room;
The number of times an items from that location was taken to a hold location;
The number of times an item from that location was taken to a check out location;
The number of times an item from that location was sold;
The number of times an item from that location was returned.

For each of the above calculations, determine the number of occurrences per item (divide the value by the number of items that call that location home). Then rank home locations by each of the values above in occurrences per item. Provide this information to buyers, merchandisers, salespeople, etc. to assist with the planning of merchandise display, etc.

Note that after a store employee (such as a picker) has located a particular item, they may affix a pick ticket or identifying document to the item. This may serve to assist other employees to collect the item or provide information about the item to an inventory management process. For example, a pick ticket may include a model number, a size, an order being fulfilled, shipping instructions, etc.

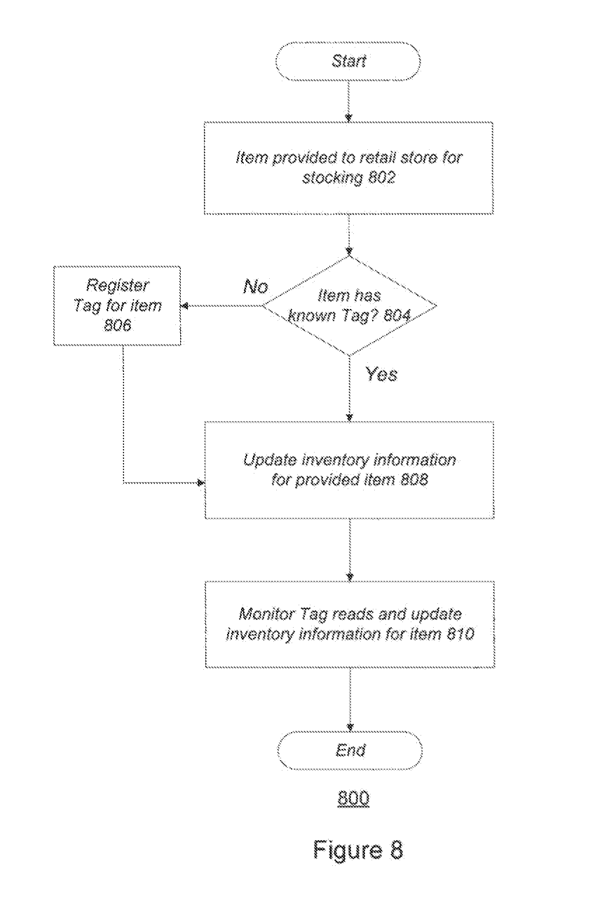

FIG. 8 is a flow chart or flow diagram illustrating an example process 800 for providing inventory services that may be used as part of a fulfillment process in accordance with an embodiment of the invention. After the process is initiated, the logic advances to block 802 where an item having an identifying “tag” (as that term is described herein) is provided to a retail store for stocking the sales floor. At the retail store, the tag is scanned by a scanning device and may also be associated with a location in the retail store. At decision block 804, a determination is made as to whether the order item has a tag that is uniquely identifiable and known to an inventory or management system, such as an Order Management Platform (element 126 of FIG. 1). If false, the control flows to block 806, where the order item is registered with the system. Next, the process steps to block 808 and the inventory for the retail store is updated to include the item and if available, the associated location. A count of the number of tags (and hence items) present in any location and at any given time or time frequency may be captured. Further, the count may also include, but is not limited to: (1) total count; (2) count by SKU; (3) count by any other logical grouping of order items having tags. Also, a record of the totality of tag provided information may be captured for any location and at any given time or time frequency.

If the determination at block 804 was affirmative, then the process would have advanced to 808 instead of block 806. In any case, moving from block 808, control flows to block 810 were the order management platform (or another system element) monitors the reading (scanning) of tags and their associated information for items in the retail store. The system may continuously update the retail store's inventory information based at least in part on the monitoring of these scanned tags.

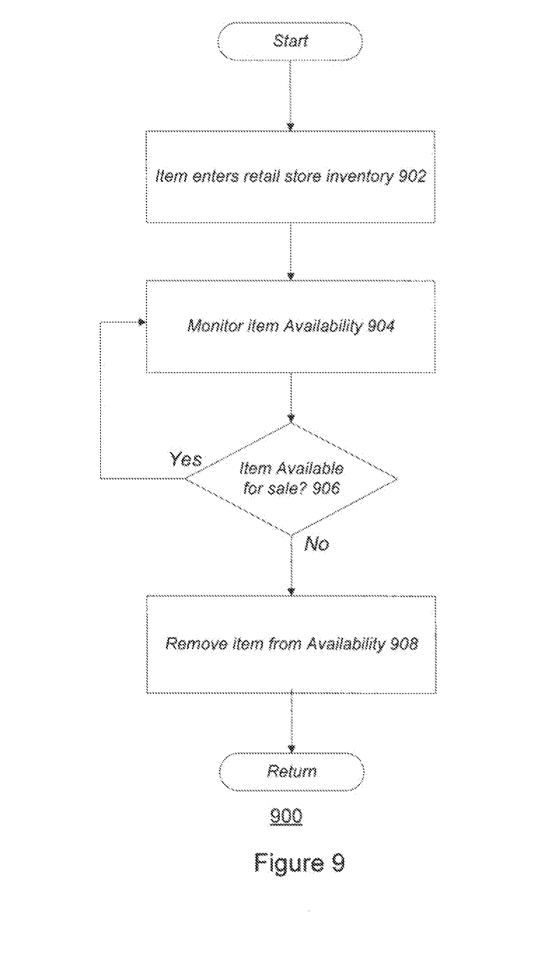

FIG. 9 is a flow chart or flow diagram illustrating an example process 900 for managing the availability of items in a retail store inventory that may be used as part of a fulfillment process in accordance with an embodiment of the invention. After initiation, control advances to block 902, where an item having a tag is associated with a particular location in a retail store and identified as an available item in the retail store's inventory. At block 904, each item having a tag that is in the retail store's inventory is monitored for availability to fulfill a sales request for a customer. Note that a sales request may be generated from an online store, in-store kiosk, point of sale terminal, store employee, mobile commerce application, etc. At decision block 906, a determination is made as to whether an item having a specific tag is still available for sale. If “Yes”, then the control loops back to block 904 and performs substantially the same actions discussed above. In one embodiment, the determination of availability for sale may be based on location information (or the movement profile) associated with the tag for the item. Similarly, the determination of the availability of an item having a specific tag may be based at least in part on a fulfillment confidence score. However, if the determination at decision block 906 is “No”, then control may flow to block 908. At block 908, in one embodiment, the order item with the specific tag is marked as unavailable and removed from the retail store's inventory as being available for sale.

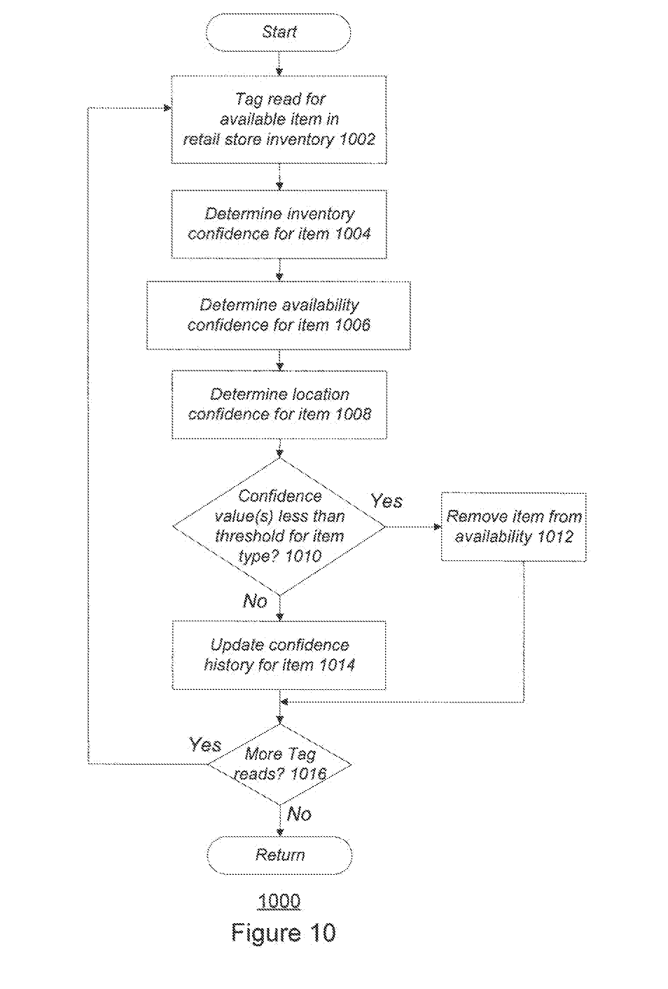

FIG. 10 is a flow chart or flow diagram illustrating an example process 1000 for using fulfillment confidence score(s) and that may be used as part of a fulfillment process in accordance with an embodiment of the invention. After initiation, at block 1002, the tag and associated information for an available item in a retail store's inventory is scanned/read. Also, location information associated with the specific tag is determined. At block 1004, inventory confidence information is determined for the item. In one embodiment, the inventory confidence information is based at least in part on various values determined by the process illustrated in FIG. 8.

Moving to block 1008, in one embodiment, availability confidence information is determined for the item. In one embodiment, various values may be calculated, including, but not limited to: (1) amount of time since tag was last read; (2) number of reads of tag in a determined time frame; (3) number of reads by different readers in a given time frame; (4) location of reads of tag; (5) total number of order items that can fulfill the sale request having the same stock keeping unit (SKU) and tags that are read in substantially the same location; (6) total number of times that the tag is taken to a dressing room; (7) total number of times that the tag was returned after purchase; (8) number of times that the tag was moved between locations; (9) number of times that the tag was moved from a back room to the selling floor of a retail store; (10) number of times and locations from which the sale request was fulfilled successfully for the order item with the tag; and (11) number of times and locations from which the sale request was unsuccessfully fulfilled for the order item with the tag. Additionally, as described herein, the various values may be assigned relative weights. Each of the weights, either singly or in combination, may be dynamically adjustable, manually adjustable, heuristically determined, determined by application of a suitable rule base, predetermined, or the like.

At block 1008, in one embodiment, location confidence information is determined for the item. At decision block 1010, a determination is made if one or more of the confidence values may be less than a determined threshold for the type of item. Note that the threshold value may be set by consideration of a specific customer's profile, buying habits, etc. If affirmative, then control advances to block 1012, where the item is removed from the retail store's available inventory. Next, the control turns to decision block 1016. Alternatively, if the determination at decision block 1010 was false, then the control would step to block 1014. At block 1014, in one embodiment, the confidence score history for the item would be updated, and control would move to decision block 1016. At decision block 1016, in one embodiment, a determination is made if more reads are to be performed of the tag and associated information. If true, control loops back to block 1002 and substantially the same actions listed above are performed. However, if the determination at decision block 1016 is found to be negative, control may be returned to a calling process.

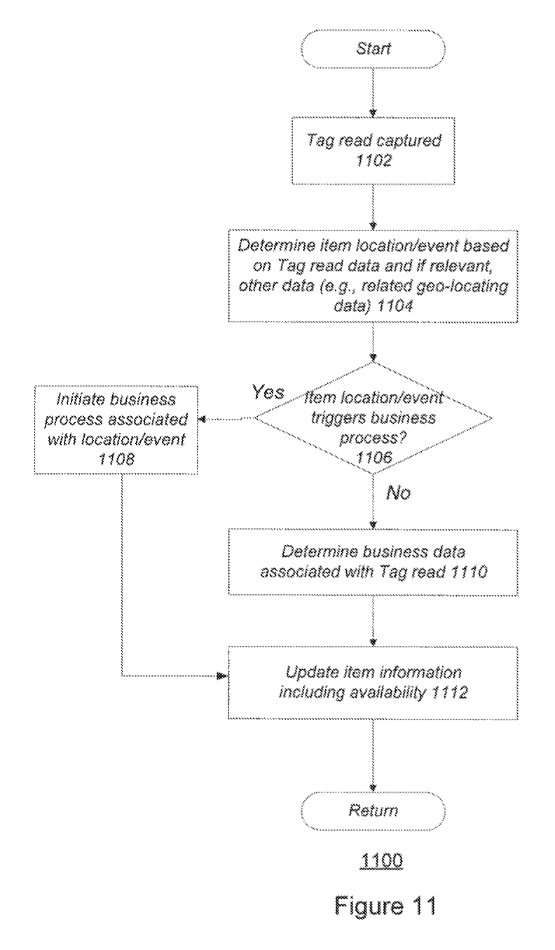

FIG. 11 is a flow chart or flow diagram illustrating an example process 1100 for managing location and/or lifecycle event data in a retail store inventory and that may be used as part of a fulfillment process in accordance with an embodiment of the invention. After initiation, at block 1102, in one embodiment, the tag for an item and associated information is read and stored. At block 1104, in one embodiment, an item's location and/or lifecycle event is determined based on scanning/reading an item tag and if relevant, capturing associated information that enables geo-locating of the item within a retail store (e.g., reading of a tag affixed to a rack, fixture, store region, etc.). In one embodiment, the tag reading provides the ability to capture the physical location of the totality of tags (and hence items) present in a location at a given time or time frequency. Additionally, as described herein, location information can be captured via a combination of fixed tags (passive or active), fixed scanners, mobile scanners or moveable tags (passive or active). The information that may be captured at each read of a unique tag, includes, but is not limited to: (1) identification of the scanner that captured the tag data; (2) identification of the tag read; (3) date and time of tag read; (4) relative or specific location of tag read; and (5) append the captured location data with any other available additional location data, such as GPS, Wi-Fi triangulation, Bluetooth, or the like (e.g., relative location to a fixture). Further, at a unique tag level, at one or more of the following information may be captured: (1) history of all tag read data; (2) calculated time since last read of an tag; and (3) total number of reads for an tag within a defined time frame.

In one embodiment, there may be one or more specific locations and/or lifecycle events that trigger the enactment of one or more different processes or operations, such as application of a rule base, heuristic, procedure, business process, or the like when an item having a tag is at that location or undergoes such an event. Such locations or events include, but are not limited to: (1) a hot pick bar such as a hold rack; (2) mailroom scale; (3) packing station; (4) dressing room; (5) cash wrap (checkout) counter; (6) a mobile, movable, or fixed point of sale (POS) device or kiosk; (7) a display window or another display location; (8) a sale; (9) a selection by a customer but no sale; (10) a selection by a customer followed by a visit to a dressing room, followed by no sale, etc. Additionally, the type of item at a specific location may also trigger the enactment of one or more different business processes. Such business processes may include application of a discount or promotional offer, prioritization of an item for picking, retrieval of an item for placement elsewhere, retrieval of an item for movement to a specific shipping location, etc.

Note that the location information may be used in one embodiment to create and maintain location specific maps of one or more of: (1) All fixed tag locations; (2) moveable tag locations; (3) item-level tag locations; and (4) scanner defined locations. Further, the location information, location maps and availability and inventory information may be used to: (1) create a coordinate grid system for each location; (2) generate dynamic pick paths that allow pickers to perform the most efficient fulfillment of tagged order items; and (3) enable pickers and other fulfillment personnel to pinpoint location of a specific tag.

In addition, such data may be used to generate a map or display depicting the movement of an item, set of items, or class of items over time, a conversion rate of an item or items as function of location within a sales area, a conversion rate as a function of item movement, etc. Such information may assist marketing and sales personnel to better display and market items to customers.

In one embodiment, pickers and other fulfillment personnel can capture one or more of the following data as part of the fulfillment process: (a) the specific location of a successful fulfillment; and (b) the specific location of an unsuccessful fulfillment. Further, pickers and other fulfillment personnel may request the next best available location from which to fulfill an order item if they indicate an unsuccessful fulfillment. Note that an order management platform may automatically reroute fulfillment requests to different locations if a fulfillment request is unsuccessful in the original location. The order management platform may also or instead automatically reroute fulfillment requests based on the calculated confidence score information.

At decision block 1106, in one embodiment, if the location and/or event information for the order item having the tag triggers a business process, control may flow to block 1108, where an applicable business process associated with the location and/or event of the item may be initiated. For example, a mailroom location may result in an employee being dispatched to the mail room to ship the order item having the tag to a customer. Similarly, an item having a tag that is located in a dressing room longer than a predetermined period of time may result in an employee being dispatched to retrieve the item and place it back on the sales floor of the retail store. Next, the process flows to block 1112, where availability information regarding the item may be updated.

If the determination at decision block 1106 is negative, then the control flows to block 1110. At block 1110, business information regarding the item having the tag is captured. Transactional and non-transactional business information may be appended to the captured tag data and any associated information. This business information may include, but is not limited to: (1) number of times the item having the tag was taken to a dressing room; (2) number of times the item having the tag was returned; (3) number of times the item having the tag was moved between locations; (4) number of times an item having the tag was moved from a back room or area to the selling floor of a retail store; (5) number of times and locations from which an item having the tag was successfully fulfilled; and (6) number of times and locations from which the item having the tag was unsuccessful in fulfilling a sales request from a customer. Next, the process flows to block 1112 and performs substantially the same actions listed above.

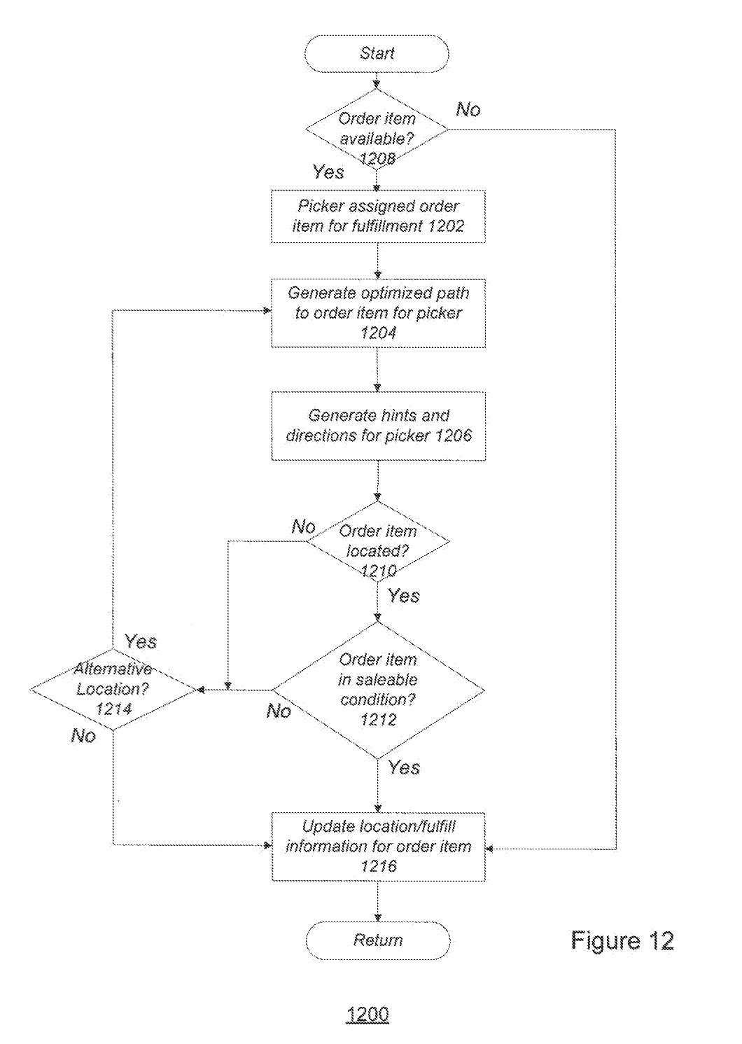

FIG. 12 is a flow chart or flow diagram illustrating an example process 1200 for a fulfillment process using item tag data that may be used in accordance with an embodiment of the invention. After initiation, in one embodiment, at block 1208 a determination is made as to whether an item is available for use in fulfilling an order. If “Yes”, then a picker or other fulfillment employee is assigned the item for fulfillment (block 1202). If “No”, then control may pass to block 1216 where data regarding the status of the item may be updated. Continuing with the “Yes” branch, at block 1204, in one embodiment, an optimized or suggested path is generated for the picker to locate and obtain an item having a tag that is believed likely to be satisfactory for fulfilling the request. The path may be optimized based at least in part on location information and a fulfillment confidence score associated with a previously read tag for an item that is located in the retail store. At block 1206, in one embodiment, directions and hints are generated for the picker that is following the path to the item having the tag.

At decision block 1210, in one embodiment, a determination is made if the item having the tag has been located by the picker. If true (the “Yes” branch), control may flow to decision block 1212, where the picker determines if the order item having the tag is in saleable condition, e.g., not shopworn or otherwise undesirable for use in fulfilling the request. If the item is in proper condition (the “Yes” branch), then control may pass to block 1216, where the location and fulfillment status of the item may be updated in the store's inventory. If negative (the “No” branch of block 1212), then in one embodiment, control may flow to block 1214, where a determination is made as to whether there is an alternative location for the picker to locate an item with a tag that is likely to fulfill the item request. If affirmative, control may then loop back to block 1204 to generate a new pick path. However, if the determination at decision block 1214 is negative, then control steps to block 1216, where the location of the item and its availability (or unavailability) in the retail store's inventory may be updated.

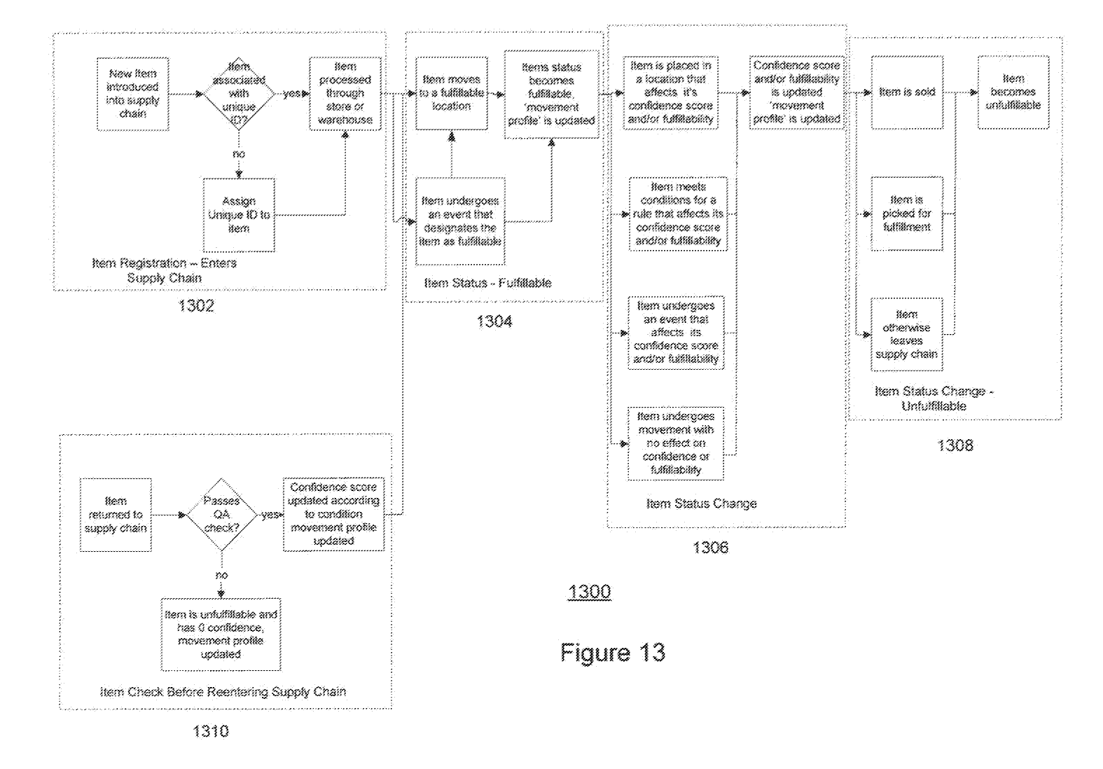

FIG. 13 is a diagram illustrating an example item “lifecycle” and events in that lifecycle as they relate to a fulfillment confidence score, in accordance with an embodiment of the invention. As shown in the example, the lifecycle of an item may include one or more phases, with examples illustrated as: (1) “Item Registration—Enters Supply Chain 1302”; Item Status—Fulfillable 1304″; “Item Status Change 1306”; Item Status Change—Unfulfillable 1308″; and Item Check Before Reentering Supply Chain 1310″. As shown, each phase may include one or more stages or events that can impact the availability and/or desirability of using a specific item for fulfilling a request.

In phase 1302, an item is introduced into the supply chain or inventory of a business. If the item lacks a unique identification (ID), it may be assigned one. Upon processing through a store or warehouse, the item may be considered available for sale or order fulfillment (e.g., this may trigger an initial fulfillment confidence score value). In phase 1304, the item may be placed in a location from which is available for sale or order fulfillment (such as a store rack, counter, warehouse shelf, etc.). In such a case a movement profile, fulfillment confidence score, or other data associated with the item may be updated. In phase 1306, the item may be subject to an event that impacts its availability for fulfillment, as that is expressed by the item's fulfillment confidence score. This may be the result of movement of the item to a dressing room, movement of the item to a shipping area, association of the item with a problem or recall, etc. In such a situation the confidence score for the item may be updated to reflect the change in its situation and changed desirability for use in fulfilling an order. In phase 1308 the overall status of the item may change due to an event such as a sale, being picked to use in fulfilling an order, etc. The item then becomes noted as un-fulfillable, that is unusable for purposes of fulfilling an order. Note that if an item is removed from the supply chain and there is an attempt to reintroduce it into the supply chain, then the item may be subject to a quality control inspection or other form of evaluation. Such may occur if the item is damaged, if its packaging is opened, etc.

As has been described, by being able to acquire and process specific information about the location of an item (such as which fixture, rack, or floor space an item currently resides on or is near), movements of an item, and/or events in the lifecycle of an item, embodiments of the invention may be used to more efficiently direct fulfillment operations and/or customers to the locations of those items. By tracking the movements and events an item experiences throughout its lifecycle more information is obtained about an individual item. This may assist in constructing build rules, algorithms, heuristics, and other analytics that look at data collected in movement profiles and enable greater understanding of the sales performance of items, the performance of a merchandising strategy, the quality of a location detection system, or the behavior of customers.

In addition to those previously mentioned, below are examples of processes, operations, and benefits that may be accomplished by tracking the location of items and their respective “lifecycle” events:
1) The “best” store from which to fulfill an order (in combination with routing logic):
Even with the use of routing logic, in today's world many businesses have no way of knowing which store location will provide the greatest likelihood of fulfillment. If an order isn't filled in the first pass it can be sent to another location for fulfillment, but this adds labor hours and becomes more expensive. Within each store there may be one or more Sku instances in one or more locations. By aggregating the Sku instances into locations and the locations into stores, one can find a store that will have the greatest chance of fulfilling the order for an item.
2) The “best” location within a store from which to pick an item for an order:
A SKU instance may exist in multiple locations—in today's world fulfillers make an educated guess about where they should look for an item. If an item has a high (or relatively high) fulfillment confidence score, then one can find the locations with the highest confidence score and send the picker or customer to the best location without further delay.
3) Infer the quality or desirability of an item:
By knowing the history of movements and events applicable to an item, one can infer its suitability for fulfillment and build a confidence score from the movement profile of that item.
4) Whether or not an item is available to use for fulfillment:
Today pickers must find items that are in dressing rooms or on hold bars—by making these items unavailable, can avoid having a picker waste time looking for an item that they are not likely to find, or will be unable to retrieve for purposes of fulfillment.
5) “Personalized fulfillment” for different customers:
Presently, each customer is treated the same for purposes of order fulfillment. But there are times when this common treatment is not satisfactory and a business may miss an opportunity to make a better impression with a new customer. For example, one could implement a rule that causes fulfillment process to use only items with the highest confidence score for certain customers or for a certain period of time, to ensure a good first impression.
6) The relative interest that customers have in an item:
Presently, businesses use sales numbers, anecdotal reports, and “gut feel” to gauge customer interest in an item. By knowing the movement profile of items, one can understand more about the pre-purchase behaviors and conversion implications for items.
7) The success of our merchandising strategy:
This is another area where “gut feel” and anecdotal information is often used to gauge success. By being able to assign a home location to each item, one can see the sales that come from items that have that location as their home and understand how well the merchandising in that location is performing. This may impact product placement and store arrangement decisions.
8) Detect issues with fit or other quality problems:
Presently, businesses rely on quality checks, fit model testing, and customer feedback to understand if there is a quality or fit issue with an item. By examining the movement profile data, one can determine how often items are abandoned in a dressing room, or traded out for another size in the dressing room, and then inspect items that have a greater than normal dressing room abandonment rate or size exchange rate to determine if there is a design, labeling, or manufacturing flaw with an item.
9) Learn about the in store browsing and shopping behaviors of customers:
By connecting item movements and events that are closely related in time or have other similarities, one can understand the ways customers browse, move about and shop in stores. This may provide insights into recommendations to customers, fulfillment options, product placement, advertising, etc.
10) Can present maps and displays of where items or a group of items currently reside in a store:
By acquiring and processing location and movement data (and then generating fulfillment confidence scores), one can display the best location to find an item. For example if someone searches for “blue polo shirt”, one can find all the locations of all the Sku instances in a store that match that criteria, and by knowing a confidence score for each instance, and the quantity of instances at each location, one can display a map of the store and overlay information about the items and their locations. Further, if certain of items are subject to a sale, discount price, or promotional offer, one can display that on the map as well. In addition, this information could be used with an augmented reality technology platform (such as a virtual reality generator) and used to generate an overlay with item information and specific location information on a live image of the store floor or a map of the store floor (e.g., utilizing a camera or video capability of a customer or employee hand held device).

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

Note that the methods, processes, operations, function, etc., depicted in the data flow diagram or flowchart illustrations can be implemented by computer program instructions. These program instructions may be provided to a processor to produce a machine, such that the instructions executing on the processor create a means for implementing the operations specified in the flowchart blocks. The computer program instructions may be executed by a suitably programmed processor to cause a series of operational actions to be performed by the processor to produce a computer implemented process for implementing the actions specified in the flowchart block or blocks. These program instructions may be stored on some type of machine readable storage media, such as a processor readable non-transitive storage media, or the like.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

1-20. (canceled)

21. A system for fulfilling a request for an item, comprising:
at least one electronic receiver;
a data transfer element associated with the item and configured to enable the at least one receiver to access data identifying the first data transfer element;
a communications network coupled to the at least one receiver and configured to transfer the data identifying the first data transfer element; and
a data processor coupled to the communications network and including a processing element programmed with a set of instructions, the processing element configured by the set of instructions to perform the steps of:
using the data identifying the first data transfer element to access data identifying the item,
determining, based on the accessed data identifying the item, a history of movement of the item within and external to a predefined chain of supply locations,
determining, in response to the processing element receiving the request for the item, a numerical fulfillment confidence score for the item based at least in part on the determined history of movement of the item, and
determining, based on the fulfillment confidence score, if the item is suitable for use in fulfilling the request.

22. The system of claim 1, wherein the data transfer element is a tag.

23. The system of claim 2, wherein the tag is a RFID tag.

24. The system of claim 1, wherein the fulfillment confidence score is determined at least in part based on one or more of a number of times that the item was determined to be in a specific supply location of the chain; a number of times the item was moved by a customer but not purchased; and a frequency with which the item is determined to have been moved over a predetermined period of time.

25. The system of claim 4, wherein the specific supply location is a dressing room.

26. The system of claim 1, wherein determining if the item is suitable for use in fulfilling the request based on the fulfillment confidence score further comprises determining if the confidence score exceeds a threshold value.

27. The system of claim 6, wherein the threshold value is dependent upon a customer for whom the request is being fulfilled.

28. The system of claim 1, wherein the processing element is further configured by the set of instructions to perform the steps of:
generating one or more screen displays to enable a user to find the item; and
providing the screen displays to the user.

29. The system of claim 8, wherein the displays include one or more of a map of a region of the supply location; an overlap on the map showing a suggested path for locating the item; and text or labels identifying locations on the map.

30. The system of claim 1, wherein the data transfer element is affixed to the item.

31. A computer-readable medium on which are stored instructions that, when executed by a processing device, enable the processing device to perform a method of fulfilling a request for an item, the method comprising the steps of:
acquiring data corresponding to a plurality of locations of the item within and external to a predefined chain of supply locations over a predetermined period of time;
generating, in response to the processing device receiving the request for the item, a numerical fulfillment confidence score for the item based on the acquired data;
determining, based on the fulfillment confidence score, if the item is suitable according to at least one predetermined criterion for use in fulfilling the request; and
using the item to fulfill the request if the fulfillment confidence score is determined to be suitable.

32. The medium of claim 11, wherein acquiring the data corresponding to a plurality of locations of the item further comprises for each of a plurality of times within the predetermined period of time:
receiving data identifying a data transfer element associated with the item;
receiving data associated with a structure within a supply location at which the item is located or is proximal to; and
processing at least one of the received data identifying a data transfer element and the received data associated with a structure to determine that the item is located at or near the structure.

33. The medium of claim 11, wherein generating a fulfillment confidence score for the item further comprises one or more of: determining a number of times that the item was determined to be in a specified region of the chain; determining a number of times the item was moved by a customer but not purchased; and determining a frequency with which the item is determined to have been moved over a predetermined period of time.

34. The medium of claim 13, wherein the specified region of the chain is a dressing room.

35. The medium of claim 12, wherein the data transfer element associated with the item is a RFID tag.

36. The medium of claim 11, wherein determining if the item is suitable for use in fulfilling the request further comprises determining if the confidence score exceeds a threshold value.

37. The medium of claim 16, wherein the threshold value is dependent upon a customer for whom the request is being fulfilled.

38. The medium of claim 12, wherein receiving data associated with a structure within a supply location further comprises receiving data identifying a second data transfer element associated with the structure or with a region of the chain.

39. The medium of claim 11, further comprising:
generating one or more screen displays to enable a user to find the item; and
providing the screen displays to the user.

40. The medium of claim 19, wherein the displays include one or more of a map of a region of the supply location; an overlap on the map showing a suggested path for locating the item; and text or labels identifying locations on the map.
